(19) United States
(12) Patent Application Publication
(10) Pub. No.: US 2018/0046763 A1
(43) Pub. Date: Feb. 15, 2018

(54) Detection and Visualization of Temporal Events in a Large-Scale Patient Database

(71) Applicants: LOYOLA UNIVERSITY OF CHICAGO, Chicago, IL (US); LOYOLA UNIVERSITY MEDICAL CENTER, Maywood, IL (US)

(72) Inventors: Ronald N. Price, JR., Darien, IL (US); Susan Zelisko, Frankfort, IL (US); Daniel Valdez, Orland Hills, IL (US)

(21) Appl. No.: 15/555,159

(22) PCT Filed: Mar. 2, 2016
(86) PCT No.: PCT/US16/20427

§ 371 Date: Sep. 1, 2017

Related U.S. Application Data
(60) Provisional application No. 62/127,763, filed on Mar. 3, 2015.

(51) Int. Cl. G06F 19/00; G06F 3/0482; G06F 17/30

(52) U.S. Cl. CPC G06F 19/322; G06F 19/3406; G06F 19/324; G06F 17/30551; G06F 17/30106; G06F 3/0482

(57) ABSTRACT

A method for detecting temporal events includes accessing a non-relational database storing patient encounter information for a plurality of encounters and patients. The stored encounter information, and rules defining a patient condition, are used to generate an input data file having a plurality of patient entries. The rules define a temporal window size and include rules for determining whether the patient condition is expressed within any given instance of the temporal window. Each patient entry includes, for each encounter associated with the patient, an encounter identifier, a temporal indicator, and one or more attribute values. The input data file is processed at least by identifying instances of the temporal window, processing portions of the patient entries that correspond to encounters that occurred within the window instances to determine whether the rule(s) is/are satisfied, and adding to an output data file an indication of whether the rule(s) was/were satisfied.

### CROSS-REFERENCE TO RELATED APPLICATION

This is a Patent Cooperation Treaty (PCT) application that claims priority to, and the benefit of the filing date of, U.S. Provisional Patent Application Ser. No. 62/127,763, entitled “Detection and Visualization of Temporal Events in a Large-Scale Patient Database” and filed on Mar. 3, 2015, the entire disclosure of which is hereby expressly incorporated by reference herein.

### FIELD OF THE DISCLOSURE

The present disclosure generally relates to healthcare and, more specifically, to systems and methods for providing clinical analytics for large volumes of data.

### BACKGROUND

Medical researchers are often interested in assessing the health of a population of patients over time, at specific points in time or in relation to a significant clinical “index event” such as a date of patient hospital admission or re-admission, death, an organ transplant, or when a particular diagnosis was first made, and so on. To assess the health of patients in relation to the index event, researchers commonly look at the patients' chronic disease state(s), with resultant comorbidities and/or comorbidity indices, and/or patient mortality. For example, researchers may want to look at pre-index event chronic disease states to determine correlations between these states and index event and/or post-index event outcomes (e.g., death, three-year survival, chronic disease expression, etc.).

Traditionally, these sorts of analyses are limited to a single time window before or after the index event. For example, a researcher may want to see which morbidities are expressed in patients in the three years prior to the index event and which comorbidities patients frequently develop within the year following the index event, and how frequently patients die within the 30 days or other defined time periods following the index event, and so on. For some health conditions, such as chronic diseases, the determination of whether a patient “has” a particular condition depends on whether corresponding rules/conditions are satisfied during a defined time window. For example, a patient may be considered to have/express chronic heart failure if, and only if, he or she was diagnosed with one or more of a certain set of International Classification of Diseases, Ninth Revision (ICD9) codes (e.g., 398.91, 402.01, 402.11, etc.) in at least one inpatient encounter and/or at least one outpatient encounter during the relevant time window. Thus, in these conventional analyses, whether the patient expresses a chronic disease of interest in the pre- or post-index event time window is typically calculated as a single, binary “yes” or “no.”

By focusing on a single time window immediately before, or immediately after, the index event, much useful information may be lost. For example, a patient may exhibit symptoms of a particular comorbidity at and/or around the time of the index event, but that information may be missed if the comorbidity is not expressed by the data corresponding to the single time window (e.g., if no diagnosis of a relevant ICD9 code was made during that particular time window). It has been shown that more statistically sophisticated/accurate models can be developed if comorbidities are determined “longitudinally” across multiple points of time, rather than a single time associated with a time window adjacent to the index event (see The Contribution of Longitudinal Comorbidity Measurements to Survival Analysis, C. Y. Wang, et al, July 2009, referred to herein as “the Wang article”). Unfortunately, determining comorbidities in even a single time window, much less longitudinally across many points in time, can be a very difficult task when using large patient databases, such as electronic medical record (EMR) databases that may contain repetitive, time-oriented data for millions of patients, tens of millions of encounters, and hundreds of billions of data points. One problem lies in the fact that data is typically not available in a form that readily supports the necessary calculations, and so dedicated software code must be written for each different project (e.g., each chronic diseases of interest, each time period of interest, etc.). Moreover, conventional approaches using relational databases (e.g., the Structured Query Language (SQL) databases offered by Oracle, Sybase and DB2) are difficult to scale to very large patient populations and very large numbers of encounters due to the processing inefficiencies inherent in relational data structures, including the need for a very large number of repetitive SQL queries. As a result, researchers are typically unable to fashion and refashion their research queries without a substantial amount of re-work, and without a large amount of computational resources. Further, even if such information could be efficiently generated, the massive quantity of produced data may be difficult to analyze in a useful way.

### BRIEF DESCRIPTION OF THE DRAWINGS

The figures described below depict various aspects of the system and methods disclosed herein. Each figure depicts an embodiment of a particular aspect of the disclosed system and methods, and each of the figures is intended to accord with a possible embodiment thereof.

FIG. 1 depicts an example system including components associated with detecting and/or visualizing temporal events in a large-scale patient database, according to an embodiment.

FIG. 2 depicts an example methodology for determining times at which a chronic disease or other condition is expressed, according to an embodiment and scenario.

FIG. 3 depicts an example user interface display for selecting visualization parameters, according to an embodiment.

FIG. 4 depicts an example set of thumbnail visualizations each corresponding to the selected alignment variable and a different one of a set of temporal variables, according to an embodiment and scenario.

FIG. 5 depicts an example expanded version of a single thumbnail visualization, according to an embodiment and scenario.

FIG. 6 depicts an example display for presenting statistics for patients expressing (1) some or all of the selected temporal variables in accordance with the temporal variable logic, and (2) the selected alignment variable, according to an embodiment.

FIG. 7 depicts an example display for presenting the statistics of FIG. 6 in graphical form, according to an embodiment.

FIG. 8 depicts an example display for presenting a temporal distribution of patients expressing (1) some or all of the selected temporal variables in accordance with the temporal variable logic, and (2) the selected alignment variable, according to an embodiment.

FIG. 9 depicts an example display for presenting statistics for patients expressing some or all of the selected temporal variables in accordance with the temporal variable logic, but not expressing the selected alignment variable, according to an embodiment.

FIG. 10 depicts an example display for presenting the statistics of FIG. 9 in graphical form, according to an embodiment.

FIG. 11 depicts an example display for presenting the frequency of various sequences of temporal variable expression for patients expressing (1) some or all of the selected temporal variables in accordance with the temporal variable logic, and (2) the selected alignment variable, according to an embodiment.

FIG. 12 depicts an example display for presenting reference information associated with a particular visualization, according to an embodiment.

FIG. 13 depicts a first example display for presenting links to resources related to conditions of interest, according to an embodiment.

FIG. 14 depicts a second example display for presenting links to resources related to conditions of interest, according to an embodiment.

FIG. 15 depicts a third example display for presenting links to resources relating to conditions of interest, according to an embodiment.

FIG. 16 is a flow diagram of an example method for detecting temporal events using patient database information, according to an embodiment.

FIG. 17 is a flow diagram of an example method for visualizing temporal events for a patient cohort, according to an embodiment.

FIG. 18 is a flow diagram of another example method for visualizing temporal events for a patient cohort, according to an embodiment.

### DETAILED DESCRIPTION

### I. Introduction

The present embodiments relate to systems and methods associated with the detection and/or visualization of temporal events (e.g., chronic disease states, and/or other clinical or non-clinical conditions) represented by the data of a large-scale patient database. In some of these embodiments, Hadoop/Hive technologies are used to store the patient data in a non-relational database using data models suitable for both structured and unstructured data types. For example, the patient data may be stored using a system, a patient database and/or data models similar to those shown and described in U.S. patent application Ser. No. 14/583,743, entitled “System and Method for Creation, Operation and Use of a Clinical Research Database” and filed on Dec. 23, 2014 (referred to herein as “the CRDB patent application”), the disclosure of which is hereby incorporated by reference herein in its entirety.

### II. Exemplary System for Detecting and/or Visualizing Temporal Events in a Large-Scale Patient Database

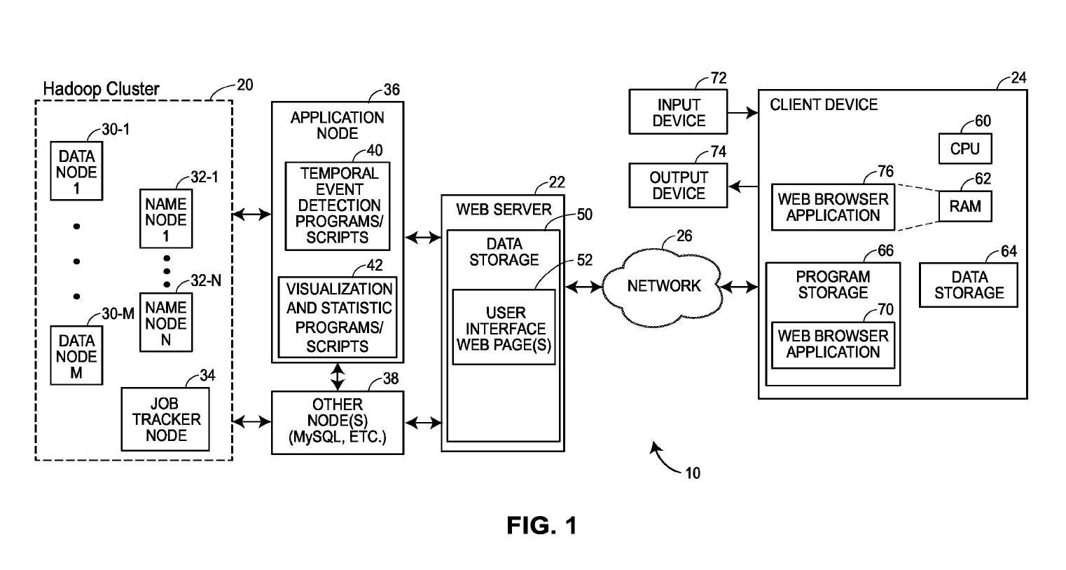

FIG. 1 depicts an example system 10 including components associated with detecting and/or visualizing temporal events in a large-scale patient database, according to an embodiment. The example system 10 includes a Hadoop cluster 20, a web server 22 and a client device 24. The Hadoop cluster 20, the web server 22, and/or other components of the system 10 may be maintained by an institution or entity such as a hospital, a university, a private company, etc., and the client device 24 may be a computing device of an end-user of the system 10 (e.g., a doctor, resident, student, informatics staff member, patient, etc.). The client device 24 may be communicatively coupled to the web server 22 via a network 26. Network 26 may be a single communication network, or may include multiple communication networks of one or more types (e.g., one or more wired and/or wireless local area networks (LANs), and/or one or more wired and/or wireless wide area networks (WANs) such as the Internet).

The Hadoop cluster 20 may include a number of nodes and servers for storing the information of the patient database, and for performing various processing operations with respect to that data. In the embodiment of FIG. 1, for example, the Hadoop cluster 20 includes M data nodes 30-1 through 30-M (M being any integer greater than or equal to one, such as six, eight, etc.), N name nodes 32-1 through 32-N (N being any integer greater than or equal to one, such as one, two, etc.) and a job tracker node 34. Each of the nodes may represent a distinct physical server device, or some or all of the nodes may be combined on a single physical server, in various different embodiments. Moreover, the nodes may all be physically/geographically located in one place, or distributed and communicatively coupled by one or more LANs and/or WANs. Generally, data nodes 30-1 through 30-M may store the patient database information (e.g., patient encounter information), name nodes 32-1 through 32-N may manage a virtual file system of the Hadoop cluster 20, and job tracker node 34 may distribute tasks (e.g., MapReduce tasks) to specific other nodes in the Hadoop cluster 20.

The Hadoop cluster 20 may implement a Hadoop framework, such as Apache Hadoop, and may support a Hadoop distributed file system (HDFS) that splits files into blocks distributed among the data nodes 30-1 through 30-M. The stored data may correspond to any of one or more non-relational, complex, Hive-supported data types, such as structures, arrays, structures of arrays and/or arrays of structures, for example. The data may include patient demographic information (e.g., age, gender, race/ethnicity, etc.), encounter type information (e.g., inpatient, outpatient, emergency, etc.), lab result information, medication information, diagnosis information, surgical procedure information and/or flowsheets, for example, and may include data collected from one or more medical centers, hospitals and/or other institutions (e.g., data converted from electronic medical record (EMR) systems of those institutions).

The example system 10 may also include an application node 36 and one or more other nodes 38. The application node 36, and one, some or all of the other node(s) 38, may be coupled to the Hadoop cluster 20, and to each other, via one or more LANs and/or WANs, and/or via one or more direct cable connections in a rack, for example. The application node 36 may implement various types of middleware, including temporal event detection programs/scripts 40 and visualization and statistic programs/scripts 42. The temporal event detection programs/scripts 40 may comprise Python, Hive and/or other programs and/or scripts that use the information stored in data nodes 30-1 through 30-M to detect the expression of chronic diseases longitudinally (i.e., at a number of different times) for each patient. Chronic disease expression may be detected in accordance with the Centers for Medicare and Medicaid Services (CMS) definitions, for example. Alternatively, or additionally, the temporal event detection programs/scripts 40 may detect the longitudinal expression of other clinical or non-clinical events or conditions, such as non-chronic diseases (e.g., individual ICD9 codes, ICD10 codes, etc.), medication use, abnormal lab values, and so on. In some embodiments, the temporal event detection programs/scripts 40 execute a temporal event detection process such as that described below in Section III.

The visualization and statistic programs/scripts 42 may use the longitudinal disease/condition/event data output by the temporal event detection programs/scripts 40 to generate various visual displays and/or statistics that may enable a user to more quickly and intuitively grasp correlations, pattern and/or relationships among chronic diseases (and/or other defined conditions or events) of interest. In some embodiments, the visualization and statistic programs/scripts 42 use the data output by visualization and statistic programs/scripts 42 to generate the visualizations and/or statistics described below in Section IV.

The application node 36 may also include programs and/or scripts for one or more other processes, such as generating various patient and/or encounter metrics and/or performing various operations in response to user queries (e.g., as described in the CRDB patent application).

The other node(s) 38 may include one or more additional nodes needed for operation of the Hadoop cluster 20 and/or for operations external to the Hadoop cluster 20. The application node 36 may submit jobs to the Hadoop cluster 20, receive results from the Hadoop cluster 20, and parse and upload the results to a MySQL database included in other node(s) 38, for example. One or more types of processes on the Hadoop cluster 20 may also upload and/or download data directly to and/or from a MySQL database in other node(s) 38.

The web server 22 may be coupled to the application node 36 and/or one or more of the other node(s) 38 via one or more LANs and/or WANs, and/or via one or more direct cable connections in a rack, for example. The web server 22 includes a data storage 50, which may be a persistent memory storing one or more user interface web pages 52 for a web-based application that allows users to access/use the patient database. The user interface web page(s) 52 may include HyperText Markup Language (HTML) instructions, JavaScript instructions, JavaServer Pages (JSP) instructions, and/or any other type of instructions suitable for defining the content and presentation of the web page(s) 52.

While many users and client devices may access web page(s) 52 and use the patient database, for clarity FIG. 1 illustrates only the example client device 24 of a single user. Client device 24 may be a personal computer (e.g., desktop, laptop, notebook), or any other suitable stationary or portable computing device, such as a tablet or smartphone, for example. As illustrated in FIG. 1, client device 24 may include a central processing unit (CPU) 60 to execute computer-readable instructions, a RAM 62 to store the instructions and data during operation of programs, a data storage 64 that may include persistent memory to store data used by the programs executed by CPU 60, and a program storage 66 that may include persistent memory to store the programs/instructions executed by CPU 60, including, for example, a web browser application 70. By way of example, the data storage 64 and/or the program storage 66 may be implemented on a hard disk drive coupled to CPU 60 via a bus (not shown in FIG. 1). More generally, the components 60, 62, 64 and 66 may be implemented in any suitable manner according to known techniques. While client device 24 in the example of FIG. 1 includes both storage and processing components, client device 24 may instead be a so-called “thin” client that depends upon another computing device for certain computing and/or storage functions. For example, data storage 64 and/or program storage 66 may be external to client device 24 and connected to client device 24 via a network link.

Further, client device 24 may be coupled to an input device 72 that allows the user to enter inputs to client device 24, and an output device 74 that allows the user to view outputs/displays generated by client device 24. The input device 72 may be a pointing device such as a mouse, keyboard, trackball device, digitizing tablet or microphone, for example. The output device 74 may be a display monitor, for example. In one embodiment, input device 72 and output device 74 may be integrated as parts of a single device (e.g., a touch screen device). Using the input device 72 and the output device 74, a user may be able to interact with graphical user interfaces (GUIs) provided by the web browser application 70 of client device 24.

When CPU 60 executes the web browser application 70, RAM 62 may temporarily store the instructions and data required for its execution. In FIG. 1, the web browser application 70 being executed is represented in the program space of RAM 62 as web browser application 76. When the user uses the web browser application 76 to access one of the web page(s) 52, for example, the page may be stored as a local copy (not shown in FIG. 1) in RAM 62, and the web browser application 76 may interpret the instructions of the local copy to present the page to the user and allow the user to interact with the page.

In operation, the temporal event detection programs/scripts 40 may pre-calculate chronic disease states for a number of different chronic diseases, for all (or many) of the patients and encounters represented in the patient database stored in data nodes 30-1 through 30-M (e.g., by iteratively applying the process described below in Section III). For example, the temporal event detection programs/scripts 40 may include code representing the appropriate rules (e.g., CMS definitions) for expression of each of a set of 25 chronic diseases. The temporal event detection programs/scripts 40 may then calculate/determine, for all patients of interest, whether each of those 25 chronic diseases is expressed, at each and every time represented in the patient database. For example, the process implemented by the temporal event detection programs/scripts 40 may calculate expression of a chronic disease for a particular patient at the time of each encounter associated with that patient (e.g., by looking at encounters and diagnoses within a suitably sized temporal window prior to each encounter). Because chronic diseases are by definition ongoing, a patient may be presumed to have a particular chronic disease at all times subsequent to the earliest temporal window in which the disease was determined to be expressed.

The temporal event detection programs/scripts 40 may store the results (chronic disease state determinations) in a results database in a persistent memory of application node 36, for example, or in a memory located elsewhere. Moreover, the temporal event detection programs/scripts 40 may add to the results database as new patient/encounter data is stored in data nodes 30-1 through 30-M, either periodically or on another suitable basis.

A user of client device 24 may then use the web browser application 76 to access web page(s) 52 via network 26 (e.g., via the Internet). By providing informational displays and interactive controls, the web page(s) 52 may enable the user to define a set of parameters for one or more desired visualizations and/or statistic sets. The visualization and statistic programs/scripts 42 may detect the user inputs via communications from web server 22 and, based on those inputs, access the results data generated by the temporal event detection programs/scripts 40 to provide display data and/or statistical data corresponding to the desired visualization or statistics. Some example web page user interfaces, visualization displays, and statistic displays are described below in Section IV. In other embodiments, the temporal event detection programs/scripts 40 do not pre-calculate all possible chronic disease states. In these embodiments, the visualization and statistic programs/scripts 42 may submit processing requests to the temporal event detection programs/scripts 40, and the temporal event detection programs/scripts 40 may submit a corresponding job to the Hadoop cluster 20, on an “as needed” basis to obtain the desired information/data.

As noted above, in some embodiments, the temporal event detection programs/scripts 40 may also, or instead, detect the longitudinal expression of other clinical or non-clinical events or conditions, such as non-chronic diseases (e.g., individual ICD9 or ICD10 codes), medication use, abnormal lab values, and so on. Moreover, in an alternative embodiment, the user may access the patient database using a downloaded software component (e.g., a software component that is downloaded and stored in program storage 66) rather than a web page accessed via web browser application 76. For example, client device 24 may be a tablet or smartphone of the user, and program storage 66 may store a tablet or smart phone application that was previously downloaded from web server 22 (or another server) via network 26. In such an embodiment, the tablet or smart phone application may generate the user interface, visualization and/or statistic displays discussed below in Section IV, and may communicate with the application node 36 and/or another server in Hadoop cluster 20 (e.g., to submit visualization and/or statistic requests and receive the results) via network 26.

### III. Exemplary Process for Detecting Temporal Events in a Large-Scale Patient Database

In an embodiment, programs and/or scripts execute a process for detecting temporal events (e.g., chronic disease expressions across time) in a large-scale patient database, such as the database stored in data nodes 30-1 through 30-M of FIG. 1, for example. In one embodiment, some or all of the process is implemented by the temporal event detection programs/scripts 40 of the application node 36 in FIG. 1. In other embodiments, a different node and/or computing device implements the temporal event detection process (or a portion thereof).

In a first step of the process for detecting temporal events, according to one embodiment, a rule may be defined for evaluation. The rule may correspond to a specific condition of interest (e.g., a specific chronic disease), and may be codified in various different ways in different embodiments. It is noted that, while the process described below primarily refers to chronic disease calculations, the process may instead, or additionally, be used to efficiently detect the expression of other clinical or non-clinical conditions or events, such as non-chronic diseases (e.g., individual ICD9 or ICD10 codes), medication use, abnormal lab values, and so on. As one more specific example, a non-chronic disease of interest may be obesity. As long as the prerequisites for the condition(s) or event(s) is/are well-defined enough to be codified, and can be evaluated with the data stored in the patient database, the condition(s) or event(s) may be evaluated in an efficient manner (e.g., with a relatively short run time) and temporally expressed on a large scale.

In one embodiment, the rule defined at the first step may be codified as a set of one or more “target flags,” a desired temporal window (e.g., 30 days, 6 months, 1 year, etc.), and a target condition to be evaluated. Each target flag may represent a count of the number of time points (e.g., encounters) at which the target condition is evaluated to be “true,” within the time period bounded retrospectively by a particular instance of the temporal window. For example, if the condition of interest “chronic diabetes” has been defined (e.g., according to the CMS definition) as an expression of any ICD9 code(s) in the 250.X range in at least one inpatient encounter/setting, or at least two outpatient encounters/settings, within a two-year period, then the rule may be codified as the target flags {1,0,0,0,2,0,0,0}, a temporal window of 730 days (i.e., two years), and a target condition of “ICD9=250.X” (i.e., any ICD9 code beginning with “250.”). In this example, the first target flag value (“1”) indicates the minimum number of inpatient encounters for which a diagnosis must match the target condition, and the fifth target flag value (“2”) indicates the number of outpatient encounters for which a diagnosis must match the target condition. The calculated expression will be positive if either of the preceding two flag conditions are met. Generally, each target flag may correspond to a particular type of encounter (e.g., inpatient, outpatient, etc.) and/or the type of diagnosis (or diagnoses) matching the target condition (e.g., primary diagnosis, secondary diagnosis, either primary or secondary diagnosis, etc.). In the above example with eight flag states, for instance, the flag states may be:
1^{st} target flag: # of inpatient encounters where any diagnosis matches target condition (e.g., in the chronic disease example, an ICD9 code in the 250.X range)
2^{nd} target flag: # of inpatient encounters where primary diagnosis matches target condition
3^{rd} target flag: # of inpatient encounters where secondary diagnosis matches target condition
4^{th} target flag: # of inpatient encounters where primary or secondary diagnosis matches target condition
5^{th} target flag: # of outpatient encounters where any diagnosis matches target condition
6^{th} target flag: # of outpatient encounters where primary diagnosis matches target condition
7^{th} target flag: # of outpatient encounters where secondary diagnosis matches target condition
8^{th} target flag: # of outpatient encounters where primary or secondary diagnosis matches target condition
   In other embodiments, other suitable types of rule sets may be used for particular target conditions.

In the above example for chronic diabetes, the 730 day window may specify that all encounters for the patient that occurred within the 730 days prior to the currently assessed encounter are to be evaluated to determine whether the target condition was satisfied for that time period. It is noted that, while 730 days may be the appropriate temporal window for chronic diabetes under the CMS definition, the window may be longer or shorter than 730 days if a different (non-CMS) definition is used. Moreover, the window size may, in some embodiments, vary based on the chronic disease (or other type of condition). If using CMS definitions, for example, the appropriate window may be 730 days for chronic diabetes, but 365 days for chronic obstructive pulmonary disease. The lowest level of temporal granularity for the temporal window may be one day, or a different suitable unit of time. Rule sets for each chronic disease condition may be stored and documented in a local control file, or stored in a remote database and accessed dynamically, for example.

In other embodiments, the rule may include more, fewer and/or different requirements. For example, the rule may further specify that data for a minimum number of encounters (or a minimum number of inpatient encounters, etc.) must be present within a particular instance of the desired temporal window in order to make a determination that the chronic disease was expressed in that window. If a rule specifies that at least six encounters must be present in a temporal window, for example, then it may be determined that the chronic disease is not expressed in a particular window (or that the result is “inconclusive,” etc.) if only five encounters occurred during that window, regardless of whether the target condition was satisfied for those five encounters.

Some example rules for various chronic diseases, including the temporal window sizes and target conditions corresponding to those chronic diseases, are shown below in Table 1, according to one embodiment:

TABLE 1

| | Window | | | Rule/Target | Rule |
|---|---|---|---|---|---|
| Condition | Size | Criteria | ICD9 Codes | Flags | Source |
| Heart | 730 | At least 1 | 398.91, 402.01, 402.11, | 1, 0, 0, 0, 1, 0, 0, 0 | CMS |
| failure | | inpatient or | 402.91, 404.01, 404.03, | | |
| | | outpatient claim | 404.11, 404.13, 404.91, | | |
| | | where diagnosis | 404.93, 428.0, 428.1, | | |
| | | matches at least | 428.20, 428.21, 428.22, | | |
| | | 1 of ICD9 codes | 428.23, 428.30, 428.31, | | |
| | | listed. | 428.32, 428.33, 428.40, | | |
| | | | 428.41, 428.42, 428.43, | | |
| | | | 428.9 | | |
| Ischemic | 730 | At least 1 | 410.00, 410.01, 410.02, | 1, 0, 0, 0, 1, 0, 0, 0 | CMS |
| heart | | inpatient or | 410.10, 410.11, 410.12, | | |
| disease | | outpatient claim | 410.20, 410.21, 410 22, | | |
| | | where diagnosis | 410.30, 410.31, 410.32, | | |
| | | matches at least | 410.40, 410.41, 410.42, | | |
| | | 1 of ICD9 codes | 410.50, 410.51, 410.52, | | |
| | | listed. | 410.60, 410.61, 410.62, | | |
| | | | 410.70, 410.71, 410, 72, | | |
| | | | 410.80, 410.81, 410.82, | | |
| | | | 410.90, 410.91, 410.92, | | |
| | | | 411.0, 411.1, 411.81, | | |
| | | | 411.89, 412, 413.0, | | |
| | | | 413.1, 413.9, 414.00, | | |
| | | | 414.01, 414.02, 414.03, | | |
| | | | 414.04, 414.05, 414.06, | | |
| | | | 414.07, 414.12, 414.3, | | |
| | | | 414.8, 414.9 | | |
| Acute | 365 | At least 1 | 410.01, 410.11, 410.21, | 0, 0, 0, 1, 0, 0, 0, 0 | CMS |
| myocardial | | inpatient claim | 410.31, 410.41, 410.51, | | |
| infarction | | where either | 410.61, 410.71, 410.81, | | |
| | | PRIMARY or | 410.91 | | |
| | | SECONDARY | | | |
| | | diagnosis | | | |
| | | matches at least | | | |
| | | 1 of ICD9 codes | | | |
| | | listed. | | | |
| Diabetes | 730 | At least 1 | 249.00, 249.01, 249.10, | 1, 0, 0, 0, 2, 0, 0, 0 | CMS |
| | | inpatient or 2 | 249.11, 249.20, 249.21, | | |
| | | outpatient | 249.30, 249.31, 249.40, | | |
| | | claim(s) where | 249.41, 249.50, 249.51, | | |
| | | diagnosis | 249.60, 249.61, 249.70, | | |
| | | matches at least | 249.71, 249.80, 249.81, | | |
| | | 1 of ICD9 codes | 249.90, 249.91, 250.00, | | |
| | | listed. | 250.01, 250.02, 250.03, | | |
| | | | 250.10, 250.11, 250.12, | | |
| | | | 250.13, 250.20, 250.21, | | |
| | | | 250.22, 250.23, 250.30, | | |
| | | | 250.31, 250.32, 250.33, | | |
| | | | 250.40, 250.41, 250.42, | | |
| | | | 250.43, 250.50, 250.51, | | |
| | | | 250.52, 250.53, 250.60, | | |
| | | | 250.61, 250.62, 250.63, | | |
| | | | 250.70, 250.71, 250.72, | | |
| | | | 250.73, 250.80, 250.81, | | |
| | | | 250.82, 250.83, 250.90, | | |
| | | | 250.91, 250.92, 250.93, | | |
| | | | 357.2, 362.01, 362.02, | | |
| | | | 362.03, 362.04, 362.05, | | |
| | | | 362.06, 366.41 | | |
| Chronic | 365 | At least 1 | 490, 491.9, 491.1, | 1, 0, 0, 0, 2, 0, 0, 0 | CMS |
| obstructive | | inpatient or 2 | 491.20, 491.21, 491.22, | | |
| pulmonary | | outpatient | 491.8, 491.9, 492.0, | | |
| disease | | claim(s) where | 492.8, 494.0, 494.1, 496 | | |
| (COPD) | | diagnosis | | | |
| | | matches at least | | | |
| | | 1 of ICD9 codes | | | |
| | | listed. | | | |

Specifically, Table 1 shows temporal window sizes, portions of the target criteria (i.e., how many encounters within a temporal window instance must have one of the specified ICD9 codes as a diagnosis, and which type(s) of diagnosis is/are required), and the precise sets of ICD9 codes that correspond to the target conditions. Table 1 also shows the sets of target flags corresponding to the various chronic disease rules, in an embodiment where the eight target flags defined above are utilized.

In a second step of the process, an input data file may be created. The input data file may include a payload that is targeted/optimized to support the evaluation, under the rule defined in the first step, of whether a particular chronic disease is present for any given encounter. The input data file may be constructed directly from the Hadoop cluster 20, for example. The input data file may have a different entry/record for each patient in the analysis cohort. Each patient entry/record may include an embedded target payload component with one or more subcomponents. For example, each patient entry/record may include, or consist entirely of, an encounter identifier (e.g., a unique encounter identifier) for each of the patient's encounters, an encounter temporal indicator for each of the patient's encounters (e.g., the date and time associated with the encounter), and one or more attribute values. The attribute value(s) may include all of the values needed to evaluate the rule set defined in the first step above (e.g., all values needed to evaluate the target condition with respect to each target flag, or needed to evaluate each of the target flags having a non-zero value, etc.). For example, the attribute value(s) may include indications of whether the encounters were inpatient or outpatient, diagnosis codes (e.g., ICD9 and/or ICD10 codes) associated with each of the patient's encounters, indications of whether each diagnosis is a primary or secondary (or other) diagnosis, medications associated with each of the patient's encounters, clinical laboratory values associated with each of the patient's encounters, physical finds associated with each of the patient's encounters, and/or other attributes of interest alone or in combination. In the chronic diabetes example provided above, for instance, the attribute values may include the ICD9 diagnosis codes and an indication of whether those codes were associated with primary, secondary or other diagnoses. In short, the payload component(s) for a particular patient may include subcomponents carrying relevant data for all of the patient's encounters that are to be considered in the analysis.

In a third step of the process, the input data file may be efficiently consumed, one patient record at a time, by temporally parsing the payload components. To allow for more efficient processing/analysis, implementation of this step may be distributed across all nodes of the Hadoop cluster 20 of FIG. 1. The process may efficiently consume the payload component(s)/subcomponents of each patient record by repetitively identifying an appropriately-sized temporal “chunk” of the patient's payload component(s), where each temporal chunk is to be sent to an evaluation process described below in connection with the fourth step. Each “chunk” corresponds to a single instance of the temporal window as defined in the first step above. For example, each temporal chunk may include those portions of the input data file (e.g., diagnosis data, etc.) corresponding to all encounters occurring within the current instance of the temporal window. The process may step through all encounter temporal identifiers for each patient, one at a time and in time order (e.g., ascending order by date, etc.), and in this manner efficiently deconstruct the payload component(s)/subcomponent(s) on the varying temporal bounds as dictated by the temporal window size and the dates of the encounter temporal identifiers. The efficiency of this step of the process may be improved by pre-sorting the components/subcomponents in a temporally ascending order (e.g., ascending by date). Because the temporal window may be defined to be a size that is larger than the intervals between some or all of a patient's encounters, the different instances of the time window may overlap (e.g., the same encounter data may be represented in two or more different temporal chunks of data that is output by the third process step).

In a fourth step of the process, the temporal chunks (data segments) from the third step may be received, and each may be evaluated in accordance with the rule defined in the first step of the process. For each temporal chunk, a set of one or more “result flags” summarizing the analysis of that temporal chunk may be calculated. The result flags may correspond in meaning to the target flags described above. In the chronic disease example, for instance, there may be eight result flags corresponding to the eight target flags described above (e.g., a first result flag indicates the number of inpatient encounters, within the temporal window instance, in which the primary diagnosis was determined to be in the 250.X range, a second result flag indicates the number of inpatient encounters, within the temporal window instance, in which the secondary diagnosis was determined to be in the 250.X range, etc.). The state/values of the result flags for each temporal window/chunk may be stored in a memory for utilization in the next step. The payload component(s) generated in the third step contain all information needed in the evaluation process of the fourth step. In this manner, all encounters of all patients may be processed in a single pass, without the need to locate and/or access additional or external data.

In a fifth step of the process, the result flags from the fourth step may be retrieved from the memory and compared against the target flags of the rule set as defined in the first step. In one embodiment, the comparison yields a “true” or “match” indication for the temporal chunk under consideration so long as at least one result flag for that temporal chunk is equal to or greater than a corresponding, non-zero target flag (e.g., in the above example, so long as the first result flag is greater than or equal to the first target flag, or the fifth result flag is greater than or equal to the fifth target flag. More generally, in some embodiments, appropriate Boolean “AND,” “OR,” “NAND” and/or “NOR” logic operations may be used to efficiently compare the result flags for each temporal chunk to the target flags. In some embodiments, result flags are only generated, and/or compared to the corresponding target flags, for those target flags that are non-zero (e.g., the first and fifth target flags in the above example). For each temporal chunk having result flags that match the target flags (in accordance with the Boolean logic), data may be generated indicating that the chronic disease was expressed in the corresponding time window instance. The results of the comparisons for the temporal chunks (e.g., the indications of whether/when the chronic disease was expressed) across all temporal windows, and across all patients, may be output in a pre-determined format and stored in an output file (e.g., in a persistent memory of the application node 36 of FIG. 1, or in the data nodes 30-1 through 30-M, etc.). The output file may contain the results of the entire process run, and may be consumed by any number of downstream programs and analyses (e.g., the visualization and statistic programs/scripts 42 of FIG. 1).

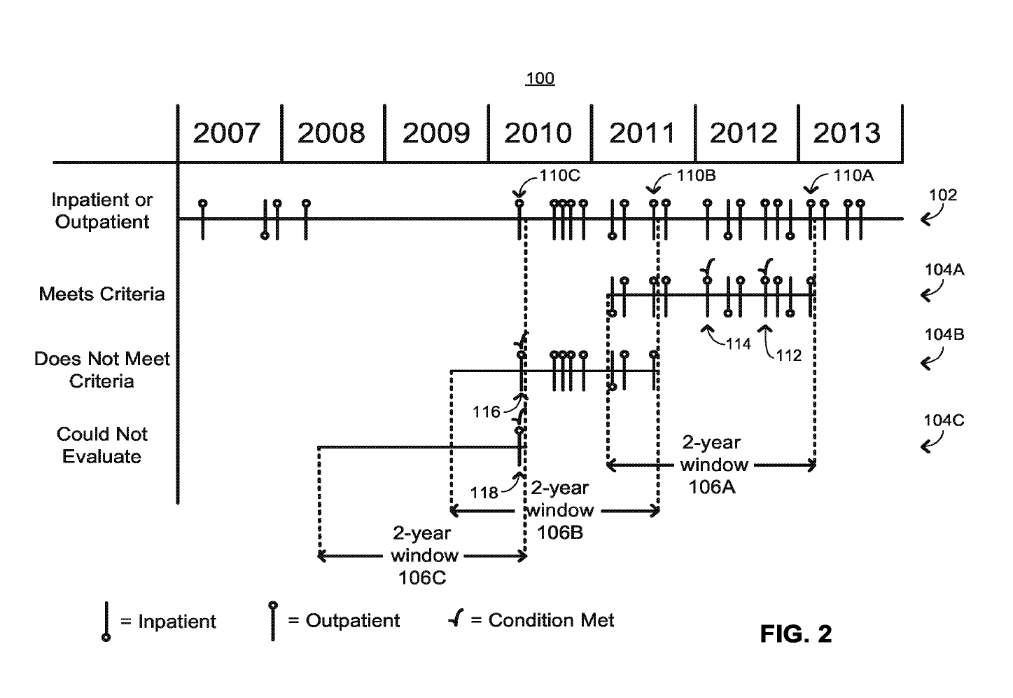

FIG. 2 provides one example embodiment and scenario of a temporal event detection process 100, which may be implemented by temporal event detection programs/scripts 40 of FIG. 1, for example. As seen in FIG. 2, a first timeline 102 depicts all of the inpatient and outpatient encounters of a single patient, over a seven-year time span, that are represented in the patient database. The example process 100 corresponds to a scenario in which a chronic disease (or other condition) of interest is defined by a target condition (e.g., an ICD9 code in a certain range or set of ICD9 codes) being met in at least two outpatient encounters, or at least one inpatient encounter, during a single 2-year window. The definition in this example also requires that at least one inpatient or two outpatient encounters be included in a particular 2-year window in order to evaluate whether the disease/condition of interest is expressed in that window.

As is also seen in FIG. 2, a second timeline 104A depicts the encounters of timeline 102 that fall within a first 2-year window instance 106A, a third timeline 104B depicts the encounters of timeline 102 that fall within a second 2-year window instance 106B, and a fourth timeline 104C depicts the encounters of timeline 102 that fall within a third 2-year window instance 106C. The window instances 106A, 106B and 106C are just three of many potential instances of the 2-year window, corresponding to the encounters 110A, 110B and 110C along timeline 102. In some embodiments and/or scenarios, for example, a different instance of the 2-year window (or any size window) is aligned with each and every one of the encounters shown within the timeline 102.

For each of the window instances 106A-106C, the target condition (e.g., ICD9 codes in a particular range or set) is tested and, if satisfied, the appropriate result flag or flags for that window instance are incremented accordingly. Rule sets for other embodiments may set or manipulate result flags as appropriate for the required testing logic. In the example of FIG. 2, within the window instance 106A, the target condition is met only at outpatient encounters 112 and 114. Because this satisfies “two outpatient diagnoses or one inpatient diagnosis,” the rule criteria are met for the window 106A, and the condition of interest (e.g., chronic diabetes, etc.) is considered to be expressed in the window 106A. Within the window instance 106B, however, the target condition is met only at outpatient encounter 116. Because this does not satisfy the rule criteria, the condition of interest is considered to be not expressed in the window instance 106B. Similarly, the target condition is met only at outpatient encounter 118 in the window instance 106C. Because only one outpatient encounter is within the window instance 106C, the expression of the disease/condition of interest cannot be evaluated at all for that time period.

In various different embodiments, each of the five “steps” described above may be a stand-alone, non-clustered/non-distributed process, a stand-alone process distributed among various cluster nodes (e.g., some or all nodes of the Hadoop cluster 20 in FIG. 1), or a full Hadoop MapReduce process distributed among all cluster nodes. Moreover, some steps may be different than other steps in this regard. For example, the first, second, fourth and fifth steps may be stand-alone, non-clustered/non-distributed processes, while the third step may be a Hadoop MapReduce process distributed among all cluster nodes.

By using the process described above, and particularly when using a Hadoop/Hive infrastructure (such as that of system 10 in FIG. 1) to produce the input data file, chronic disease states (or other clinical or non-clinical conditions/states) may be determined orders of magnitude faster than would be possible via traditional approaches. Efficiencies in generating the input data file may be greatly enhanced by using a patient database such as the clinical research database described in the CRDB patent application (e.g., by using a patient database that was generated using an extract-transform-load (ETL) process the same as or similar to the ETL process described in the CRDB patent application, and/or by using data models that are the same as or similar to the data models described in the CRDB patent application, etc.). Moreover, the process is repeatable and may be automated such that each analysis (e.g., each chronic disease condition, each temporal window, etc.) does not require much, if any, additional/customized user programming, so long as the appropriate rules (e.g., window size, target flags and target condition) are codified for each chronic disease or other condition of interest. As such, it is feasible to pre-calculate for later use the chronic disease (or other condition) status for every patient in a database (e.g., for hundreds of thousands of patients, millions of patients, etc.), at every known/available encounter for each of those patients (e.g., for millions of encounters, tens of millions of encounters, etc.), and for every pre-defined chronic disease or other condition of interest (e.g., for tens of different chronic diseases). If traditional techniques and systems were used, such calculations would likely be prohibitive in terms of programming time and/or computational resources.

The conditions/states calculated by the above process can have a myriad of different uses, such as expanding medical knowledge by determining previously unknown correlations, predictive analytics (e.g., health risk assessment), assessing hospital performance/efficacy, and so on. For example, knowledge of chronic disease states over time, calculated for each patient in a cohort, may allow quick and easy determination of longitudinal comorbidities in clinical studies, thereby supporting the “best fit” models such as those described in the Wang article. As another example, and as described in more detail below, the results of the calculations may be aggregated to provide users (e.g., researchers, doctors, residents, students, patients, etc.) large-scale, longitudinal views of each patient's chronic disease status, related comorbidity measures and/or related statistics.

### IV. Exemplary Web-Based Application for Visualizing Temporal Events in a Large-Scale Patient Database

By virtue of being both repeatable and scalable, the temporal event detection process described above in Section III is capable of generating a very large amount of data that previously could only be generated in a piecemeal fashion over a long period of time and with a great deal of ongoing effort. Once that data is generated, however, challenges remain with respect to effectively utilizing the information. Various new visualization techniques and statistical measures, described below, may enable users to gain new medical knowledge (e.g., identify previously unrecognized correlations, patterns, relationships, etc.), and/or confirm/support existing medical knowledge or theories, in a highly intuitive manner.

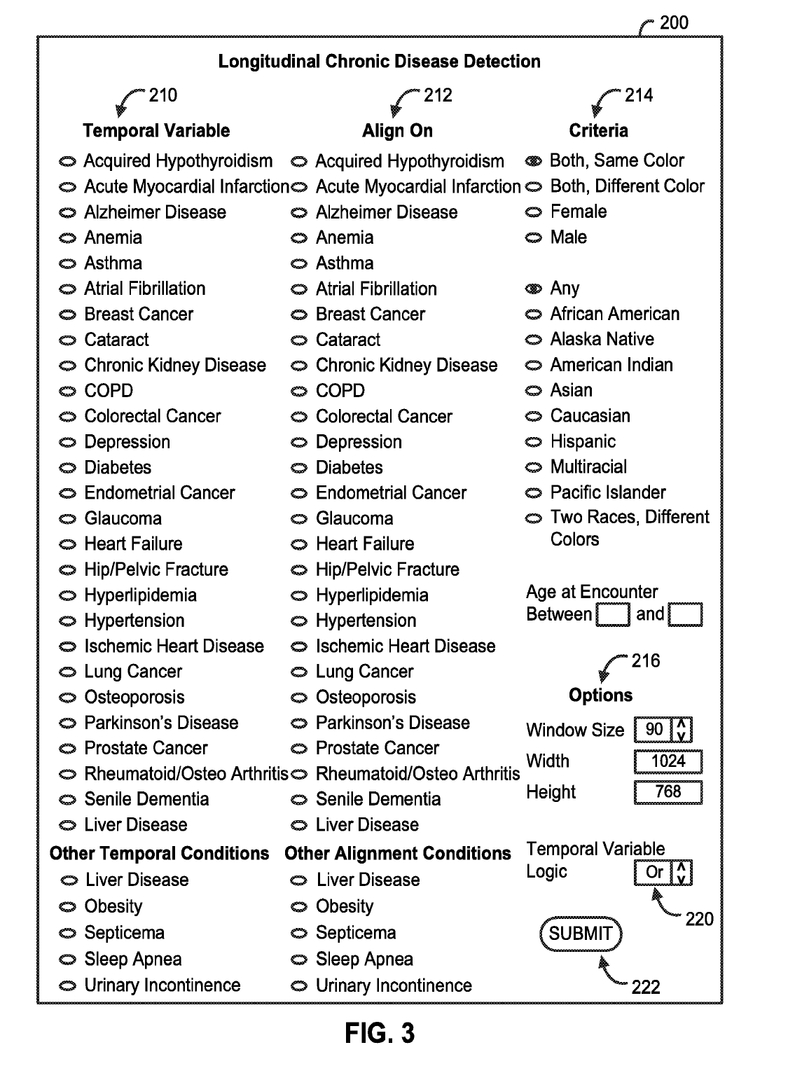

FIGS. 3-12 depict example displays provided to a user (e.g., researcher, physician, resident, student, patient, etc.) by a web-based application, according to an embodiment. The web-based application may be accessed via an internal website of an institution, for example. FIGS. 3-12 depict the displays as they might appear within a display of a web browser, for example. The user may provide inputs to (e.g., activate/select controls of) the displays that include interactive controls by actions such as keyboard entries, mouse and/or touchpad clicks and movement, touching the display screen (e.g., if the user accesses the displays using a smartphone, tablet, etc.), and/or other input means. With reference to the embodiment shown in FIG. 1, for example, the web server 22 may make one or more of web page(s) 52 available to web browser application 76 of client device 24. The web browser application 76 may then cause the output device 74 to present some or all of the displays of FIGS. 3-12 to the user in response to various user inputs (made with input device 72), and may cause the CPU 60 to recognize and act upon user inputs according to the functionality described below. The user may then view, save and/or print any of the display screens as desired.

Referring first to FIG. 3, the example user interface display 200 depicted therein may be presented to the user to enable selection of visualization parameters. As seen in FIG. 3, the user may be presented with a set of temporal variables 210 (here, 26 chronic diseases and five “other temporal conditions”) and a set of alignment variables 212 (here, the same 26 chronic diseases, and the same five other conditions), each variable being associated with a respective, selectable check box or radio button. In one embodiment, the user may select only one of alignment variables 212, but may optionally select one, some or all of the temporal variables 210. The user interface display 200 also includes radio button controls for various other visualization parameters, including “Criteria” controls 214 that allow the user to select only a certain gender and/or only certain races/ethnicities for the patients represented in the visualizations, or color-coding of the visualizations by gender and/or race/ethnicity. Still other visualization parameter controls may include “Options” controls 216 that allow the user to select a temporal aggregation window size (e.g., in number of days), a “height,” and a “width.” The height and width parameters may control the vertical size and horizontal size, respectively, of the aggregation window image in pixels, and may be adjusted to provide a subjectively better image given the display size and user preference. The aggregation window size (not to be confused with the aggregation window image) may be the lowest level of aggregated days on the x-axis, for example, with all positive expression within a given window being represented by a single set of pixels. If the aggregation window size is 90 days, for example, then any expression that occurs within the first 90 days, post-alignment event, will appear in the same set of screen pixels. In a fixed-resolution image, making the aggregation window size larger may have the effect of lumping more days into a single set of pixels, but simultaneously utilizing fewer sets of pixels to fill the screen (which may in turn have the effect of making the set of pixels larger on the display screen).

The user interface display may also include a “Temporal Variable Logic” control 220 that enables the user to select the desired Boolean logic for linking the temporal variables (as described further below), and a “Submit” button 222 to be activated by the user when the visualization parameters are at the desired settings. In some embodiments, the user interface display 200 includes different control types, such as drop-down menus, instead of (or in addition to) check boxes and/or radio buttons.

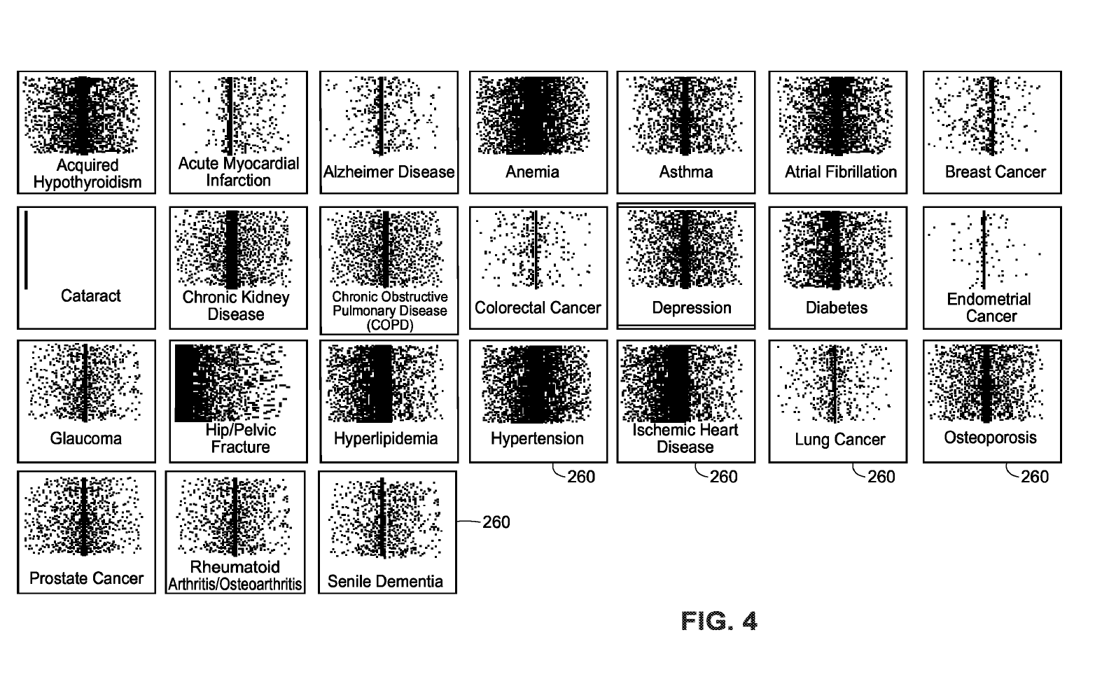

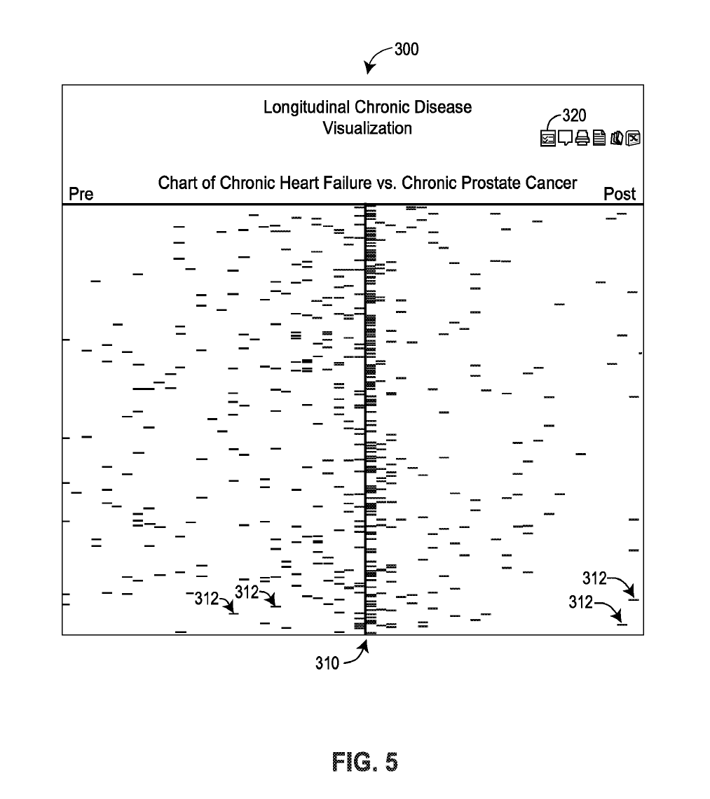

Generally, the selected one of alignment variables 212 is a condition that serves as the temporal alignment point for all patient timelines, and the first expressions of the selected one(s) of temporal variables 210 are plotted along the aligned patient timelines, as will be discussed further below in connection with FIG. 5. In some embodiments, if a user activates the “Submit” button 222 after selecting a particular alignment variable, but without having selected a temporal variable, the user is presented with a display such as the example display 250 of FIG. 4. FIG. 4 corresponds to an embodiment and scenario in which the user has selected “Heart Failure” as the alignment variable, but no specific temporal variables. As seen in FIG. 4, a set of small (e.g., 100×100 pixel), visualization “thumbnails” 260 may be presented to the user on a single display screen (possibly, but not necessarily, requiring scrolling, etc., to see all of the visualization thumbnails). Each visualization thumbnail 260 may correspond to a different temporal variable from the set of temporal variable options 210 in the display 200 of FIG. 3, and may be a miniature version of a larger visualization similar to the visualization display 300 of FIG. 5 (discussed below).

In some embodiments, each different temporal variable is associated/coded with a different color. For example, the indicators corresponding to the temporal variable expressions that are plotted along the patient timelines may be colored differently for each different temporal variable (e.g., light blue for “Diabetes,” dark gray for “Hyperlipidemia,” lime green for “Hypertension,” forest green for “Prostate Cancer,” etc.), both in the visualization thumbnails 260 and in the expanded versions of those thumbnails. In an embodiment, the user may click on, tap or otherwise select any desired visualization thumbnail 260 to expand that thumbnail view. Selecting a particular visualization thumbnail 260 may be equivalent to selecting the corresponding one of the temporal variable check boxes in the user interface display 200 of FIG. 3, and may cause that corresponding check box to be marked as having been selected.

The example display 300 of FIG. 5 corresponds to a scenario in which the user has selected the visualization thumbnail 260 for the temporal variable “Prostate Cancer” in the display 250 of FIG. 4. Alternatively, the display 300 may correspond to a scenario in which the user has directly selected the check box next to “Prostate Cancer” in the temporal variable portion (left column) of the display 200 in FIG. 3, in addition to selecting the radio button next to “Heart Failure” in the alignment variable portion (middle column) of the display 200 in FIG. 3. As seen in FIG. 5, the visualization display 300 includes a line 310 (which may be uncolored) extending vertically across most of the height of the display 300. This vertical line 310 may correspond to the time of the first expression of the alignment variable (here, heart failure) for each of the patients represented in the visualization. In various different embodiments, for example, the vertical line 310 may correspond to the date at the start, end or middle of a particular instance of the temporal window specified by the rule for the condition corresponding to the alignment variable (e.g., a 2-year window). In an embodiment, the vertical line 310 is positioned at the middle of the screen (e.g., offset from the left and right screen edges by approximately half the screen width in pixels).

In an embodiment, all patients represented in the visualization display 300 of FIG. 5 have expressed both the alignment variable condition (heart failure) and the temporal variable condition (prostate cancer). In other embodiments and/or scenarios (e.g., if multiple temporal variables are selected with “OR” logic, as discussed below), some patients may not have expressed prostate cancer. Moreover, if the user selected only a particular gender, race and/or ethnicity on the user interface display 300 of FIG. 3, then the display 300 may represent only those patients with the alignment variable condition and the selected gender/race/ethnicity.

Each represented patient may be associated with a respective horizontal timeline, with each different patient timeline being at a different vertical position on the screen. On each patient timeline, the first expression of the temporal variable for that patient, if any, may be indicated by a short, horizontal line segment or other suitable indicator 312. In an embodiment, all indicators 312 to the left of the vertical line by X pixels antedate the first expression of the alignment variable by a number of days that is proportional to X, while all indicators 312 to the right of the vertical line by X pixels postdate the first expression of the alignment variable by a number of days that is proportional to X. In scenarios where many patients are represented in the display, and/or where the condition corresponding to the temporal variable is expressed among a large percentage of the patients, some of the timelines/indicators 312 may appear to be co-aligned (or overlapping) due to the non-zero vertical pixel thickness of the indicators positioned along the patient timelines. To prevent such overlap/compression, the user may set the “height” control (shown in FIG. 3 and discussed above) such that the number of vertical pixels is at least equal to the number of patients in the cohort (though this may, depending on the number of patients, the window size, and the screen resolution, require vertical scrolling by the user in order to view the entire image).

Each indicator 312 may have a horizontal length that corresponds to the temporal aggregation window size set by the user using the “Options” controls 216 of the user interface display 200 of FIG. 3, and may be color-coded in the same manner as the corresponding thumbnail 260 (e.g., forest green for prostate cancer). The temporal aggregation window (e.g., 30 days, 60 days, 90 days, etc.) may visually aggregate data for display purposes by plotting all expressions of the temporal variable condition that occur in a particular temporal aggregation window as a single indicator/horizontal line segment 312. The overall horizontal width of the visualization display may be divided into temporal aggregation windows that are horizontally adjacent and non-overlapping, such that every horizontal pixel of the visualization is associated with one and only one temporal aggregation window. If the temporal aggregation window is 60 days, for example, then indicators 312 immediately to the left of the vertical line 310 may indicate that the first expression of the temporal variable condition was 1 to 60 days prior to the first expression of the alignment variable condition, indicators 312 immediately to the left of those indicators 312 may indicate that the first expression of the temporal variable condition was 61 to 120 days prior to the first expression of the alignment variable condition, and so on.

As described above in Section III, chronic disease (or other condition) states may have been previously calculated for each patient at the time of each encounter for that patient (e.g., by looking back over the defined temporal window, such as two years, prior to that encounter). Generally, the encounter at which the temporal variable condition was first expressed may dictate which indicator/horizontal line segment 312 is shown for a particular patient. For example, if the process of Section III determined that prostate cancer was first expressed for a particular patient in the two year window ending at an encounter that occurred 72 days after the first expression of heart failure in the patient, the visualization may show an indicator 312 in the second position to the right of the vertical line 310 for that patient's timeline. In other embodiments, the appropriate indicator/horizontal line segment 312 to show for a particular patient is determined in a different manner. For example, each indicator 312 may correspond to the mid-point, rather than the end, of the temporal window instance in which the temporal variable condition was first expressed.

The order of the patient timelines, from top to bottom on the display 300, may be determined by different factors in different embodiments. For example, the timelines may simply be arranged in ascending or descending order based on identification numbers of the patients. Alternatively, the timelines may be ordered in another manner to help the user interpret the data, such as placing the timelines with earlier first expressions of the temporal variable towards the top of the screen and the timelines with later first expressions of the temporal variable towards the bottom of the screen (e.g., such that the indicators 312 form a continuous or broken line that generally extends from the top left of the screen towards the bottom right of the screen).

If the user activated the “Submit” button after selecting two or more of the temporal variables 210 on the user interface display 200 of FIG. 3, and after selecting temporal variable logic using the “Options” control 216 (or leaving default temporal variable logic in place), the visualization display 300 may only represent those patients that expressed (1) the alignment variable condition and (2) one, some or all of the temporal variable conditions in accordance with the selected (or default) Boolean logic. For example, “OR” logic may restrict the patients represented in the display 300 to those who have expressed the selected alignment variable condition and at least one of the selected temporal variable conditions, while “AND” logic may restrict the patients represented in the display 300 to those who have expressed the selected alignment variable condition and all of the selected temporal variable conditions.

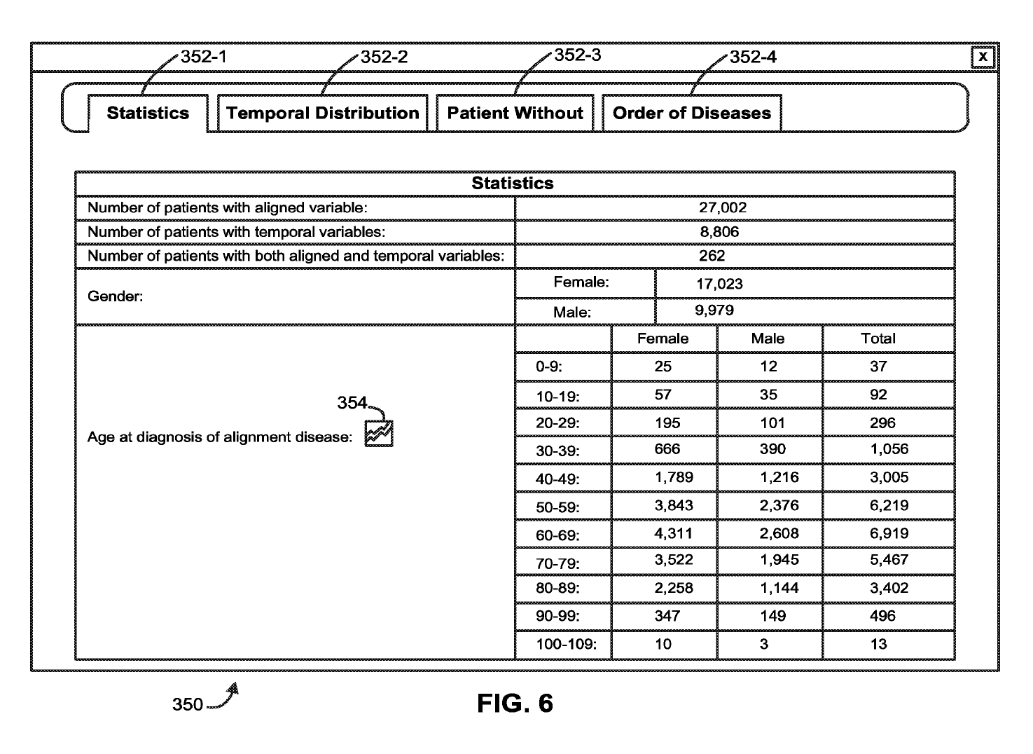

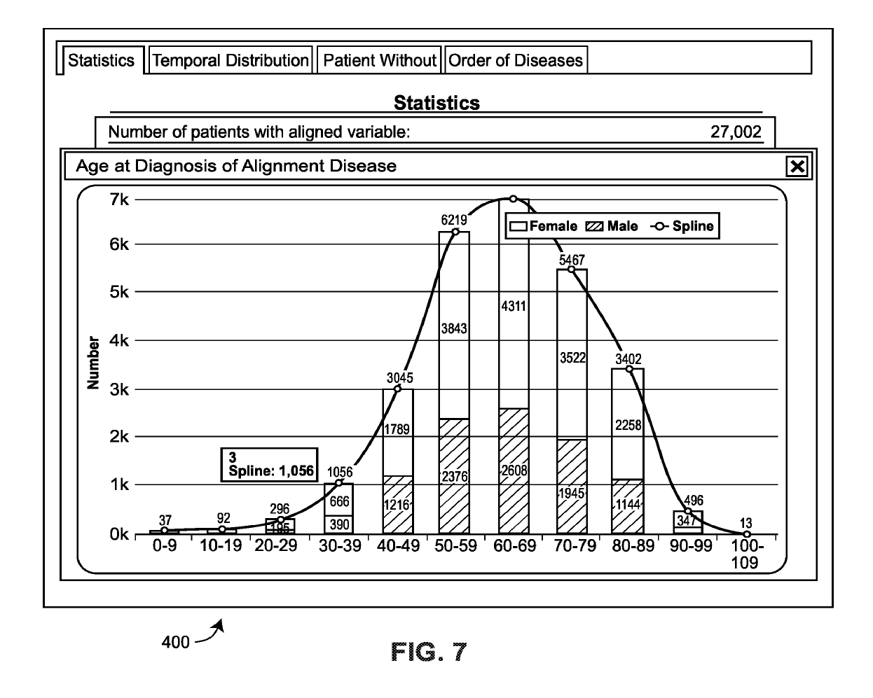

In some embodiments, one or more selectable icons, drop-down menu items, or other controls allow the user to view statistics for the patient cohort associated with the visualization display 300 of FIG. 5. For example, if the user clicks on a “statistics icon” 320 on the visualizations display 300, the display 350 of FIG. 6 may appear. As seen in FIG. 6, the user may view different statistical categories by selecting the appropriate one of tabs 352-1 through 352-4 (“Statistics,” “Temporal Distribution,” “Patient Without,” or “Order of Diseases”). FIG. 6 corresponds to the “Statistics” tab 352-1, which is for presenting statistics for patients that expressed some or all of the one or more selected temporal variables (in accordance with the selected or default temporal variable logic), and also expressed the selected alignment variable. In the example display 350 of FIG. 6, a graph icon 354 may be selected by the user to view the display 400 of FIG. 7, which presents the age statistics of FIG. 6 in graphical form.

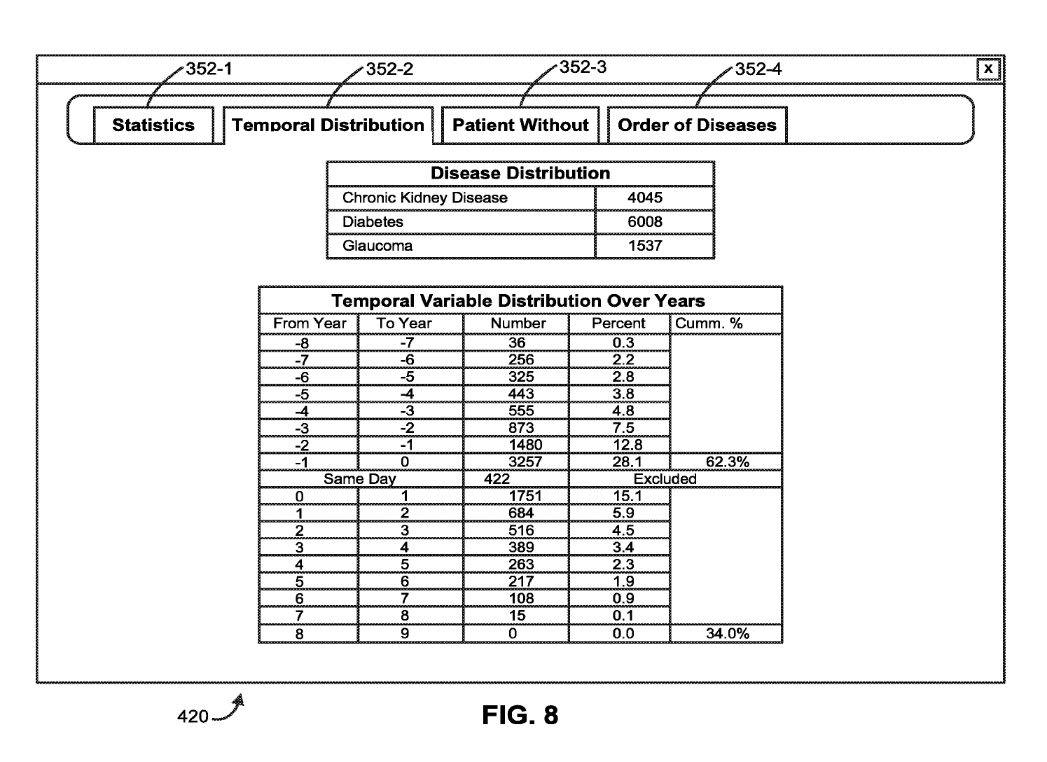

FIG. 8 corresponds to the “Temporal Distribution” tab 352-2, which is for presenting a temporal distribution of patients that expressed some or all of the one or more selected temporal variables (in accordance with the selected or default temporal variable logic), and also expressed the selected alignment variable. The display 420 of FIG. 8 represents a scenario in which at least three temporal variables (chronic kidney disease, diabetes and glaucoma) were selected by the user. The temporal distribution shown in FIG. 8 may represent the times (relative to the first expression of the alignment variable condition) at which at least one of the three temporal variable conditions was first expressed, for example.

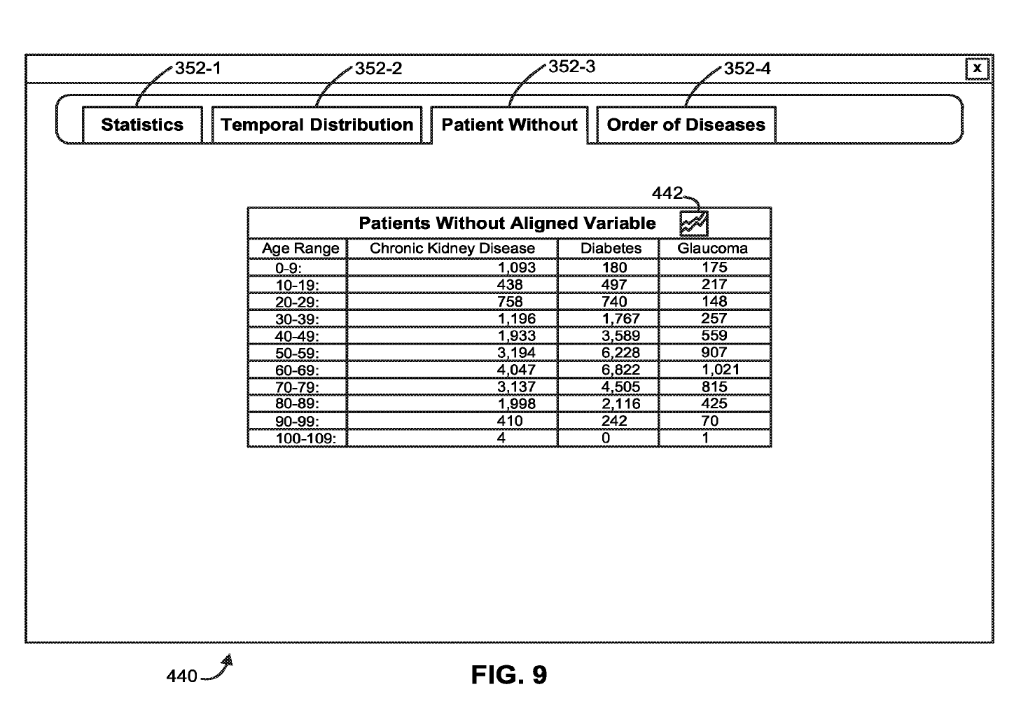

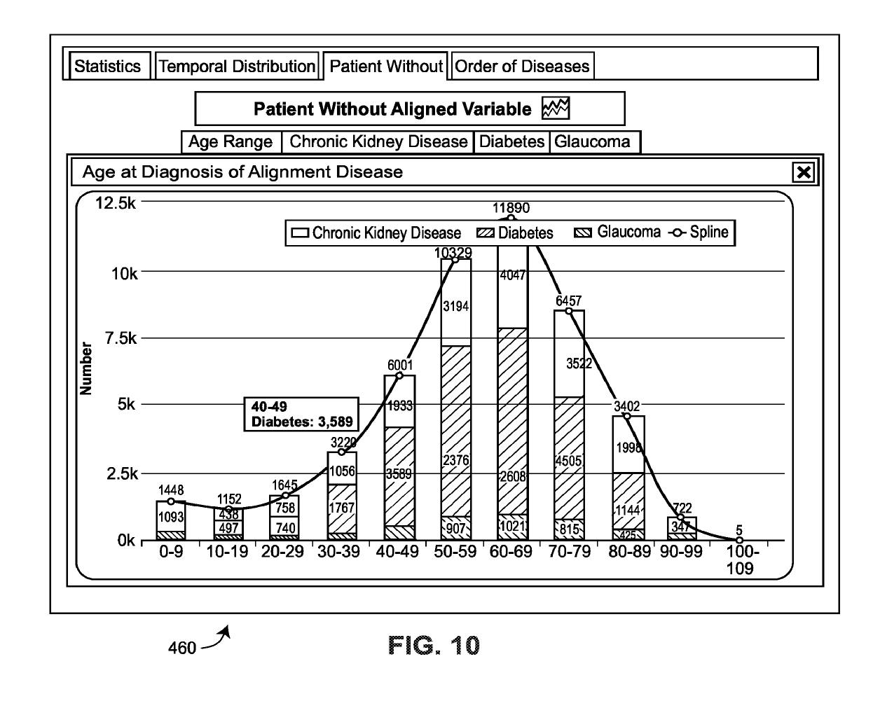

FIG. 9 corresponds to the “Patient Without” tab 352-3, which is for presenting statistics for patients that expressed some or all of the one or more selected temporal variables (in accordance with the selected or default temporal variable logic), but did not express the selected alignment variable. This data may be useful, for example, if the user determined from an associated visualization that one or more of the temporal variables are highly predictive of the alignment variable condition (e.g., if the area to the left of the vertical line in a display similar to FIG. 5 is heavily concentrated with temporal variable indicators relative to the area to the right of the vertical line). Some or all of the patients represented in the display 440 of FIG. 9 may then be determined to be at high risk of developing the alignment variable condition. In the example display 440 of FIG. 9, a graph icon 442 may be selected by the user to view the display 460 of FIG. 10, which presents the statistics of FIG. 9 in graphical form.

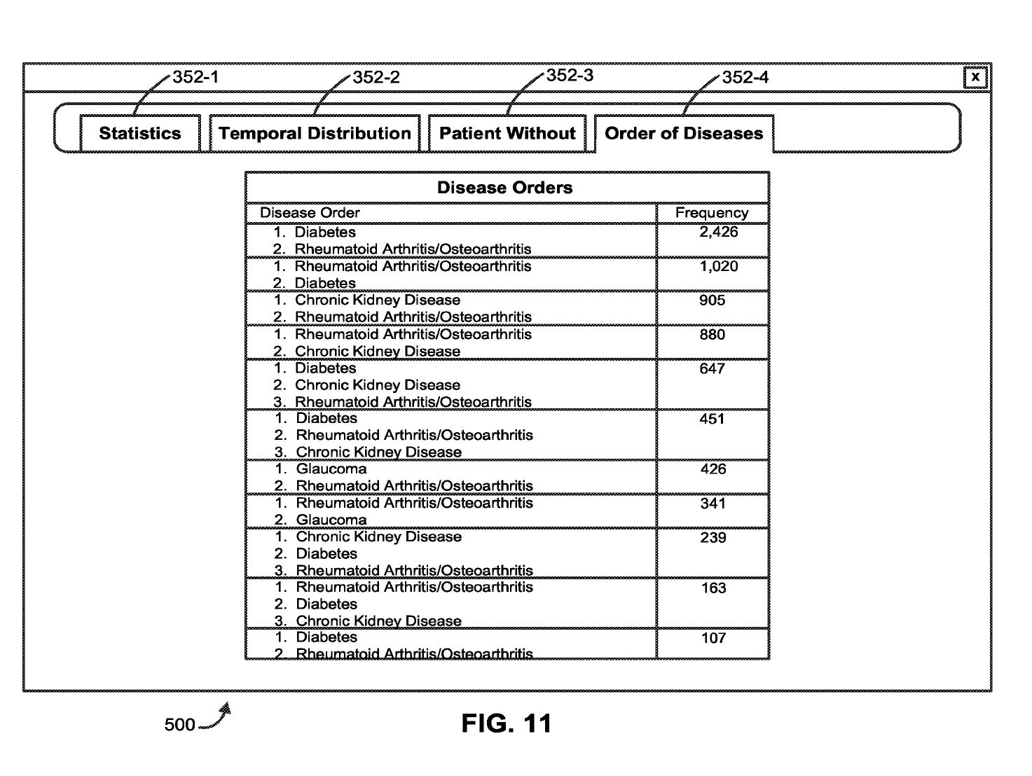

FIG. 11 corresponds to the “Order of Diseases” tab 352-4, which presents a display 500 for presenting the frequency of various sequences of temporal variable condition expression for patients that expressed some or all of the one or more selected temporal variable conditions (in accordance with the selected or default temporal variable logic), and also expressed the selected alignment variable. Based on these statistics, the user may be able to determine whether a particular sequence of comorbidities is of any particular interest, for example.

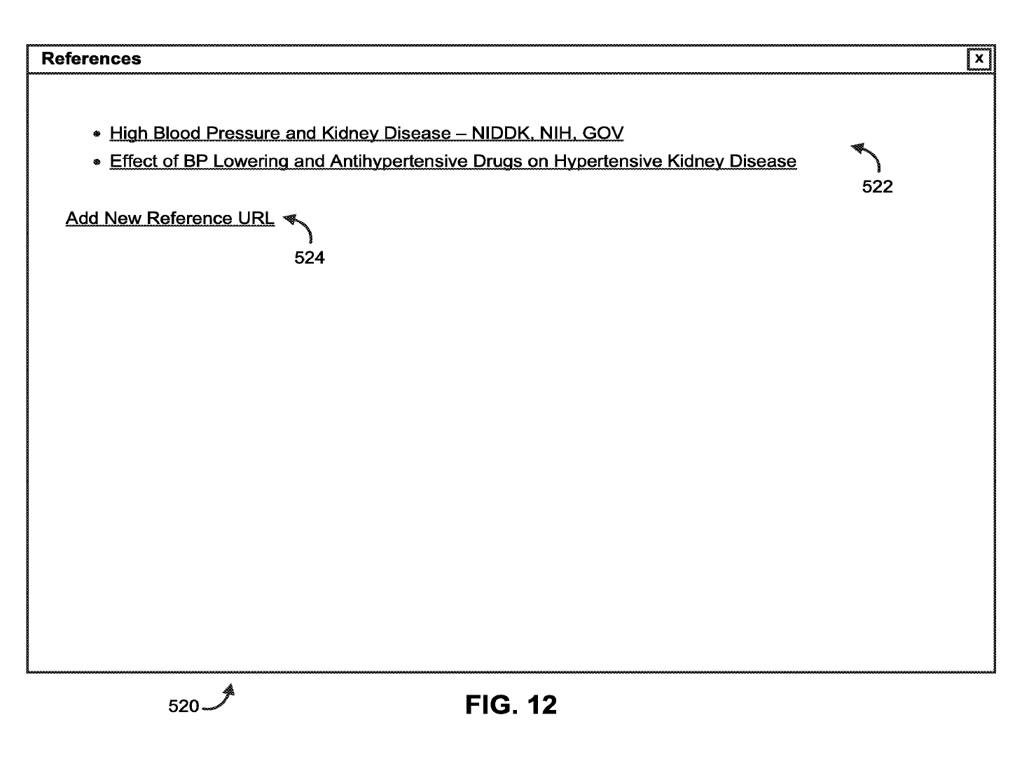

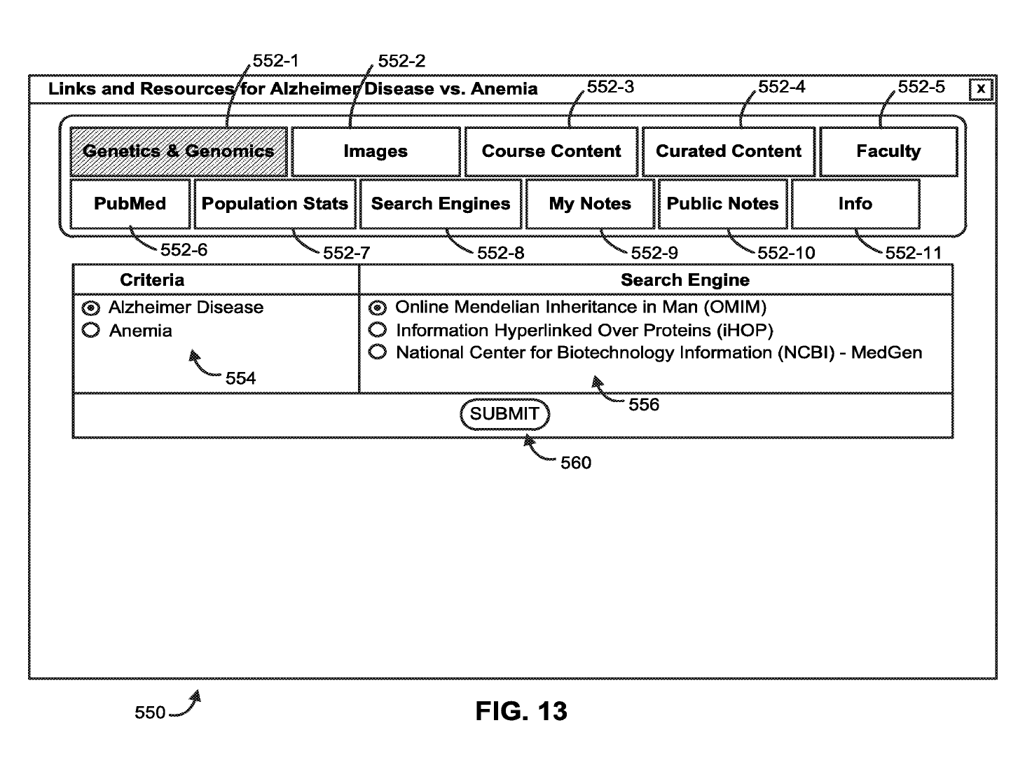

In some embodiments, one or more visualizations may also include one or more selectable icons (e.g., one of the icons shown in the top right corner of FIG. 5, similar to icon 320) or other controls that, if activated by the user, cause related reference information (and/or links thereto) to be presented to the user. FIG. 12 depicts an example of one such display 520 of reference information. The display 520 of FIG. 12 may be presented to the user in response to the user activating a reference control/icon on a visualization display in which the alignment variable is “Chronic Kidney Disease” and the temporal variable is “Hypertension,” for example, and may include hyperlinks 522 to additional information about one or both of those conditions. As seen in the example display 520 of FIG. 12, the display 520 may also include a control 524 that allows users to add or “tag” additional reference information to any visualization (e.g., to any unique combination of alignment variable and temporal variable conditions). For example, researchers may add their own reference information based on their findings using the visualization tool, physicians may add reference information reflecting their own (anonymized) patient cases/findings, teachers may add medical student curricular support materials, informatics staff may add the latest relevant research news, best practice guidelines and/or consumer-facing literature, and so on. In some embodiments, the visualization thumbnails 260 of FIG. 4 provide an indication of whether reference information is available for a particular alignment/temporal variable combination. For example, while not shown in FIG. 4, each thumbnail 260 currently associated with reference material may include a gold star (displayed on or near the thumbnail). The gold star may be selectable and serve as a hyperlink to that reference material, or may simply indicate that such material is available. Other types of links and/or references may also, or instead, be available, such as any or all of the links and references described below in Section V and/or shown in FIGS. 13-15, for example.

The visualizations and statistics described above may provide various advantages. For example, visualizations similar to that shown in FIG. 5 may enable users to quickly and intuitively identify important correlations, patterns, etc. Moreover, presenting a set of visualization thumbnails (e.g., as shown in FIG. 4) may enable users to quickly and easily zero in on temporal variables of interest.

### V. Example Links and Resources for Conditions of Interest

While the techniques described above may provide users with extremely insightful information regarding the expression of various chronic diseases and/or other conditions, that information may be of limited value if those users lack a deep understanding of one or more of the conditions at issue. Thus, it may be advantageous to provide users with quick and convenient access to additional, relevant information.

Examples of various displays that may be presented to a user for this purpose are shown in FIGS. 13-15. FIGS. 13-15 depict example displays provided to a user (e.g., researcher, physician, resident, student, patient, etc.) by a web-based application, according to an embodiment. The web-based application may be the same web-based application that provides some or all of the displays of FIGS. 3-12, for example, and the displays of FIGS. 13-15 may appear within the web browser of the same client device that generates the displays of FIGS. 3-12. The user may provide inputs to (e.g., activate/select controls of) those of the displays of FIGS. 13-15 that include interactive controls by actions such as keyboard entries, mouse and/or touchpad clicks and movement, touching the display screen (e.g., if the user accesses the displays using a smartphone, tablet, etc.), and/or other input means. With reference to the embodiment shown in FIG. 1, for example, the web server 22 may make one or more of web page(s) 52 available to web browser application 76 of client device 24. The web browser application 76 may then cause the output device 74 to present some or all of the displays of FIGS. 13-15 to the user in response to various user inputs (made with input device 72), and may cause the CPU 60 to recognize and act upon user inputs according to the functionality described below. The user may then view, save and/or print any of the display screens as desired.

Referring first to FIG. 13, an example display 550 may be presented after a user has selected “Alzheimer disease” as the alignment variable, and then subsequently selected (e.g., clicked on) a visualization thumbnail corresponding to the temporal variable “anemia.” In an embodiment where the text representing each of the alignment variables 212 in FIG. 3 is a hyperlink to a respective set of visualization thumbnails (e.g., similar to visualization thumbnails 260 of FIG. 4), for example, the user may have clicked on the “Alzheimer disease” hyperlink. In response, the user may have been presented with a display similar to display 250 of FIG. 4 (but corresponding to a scenario in which the alignment variable is Alzheimer disease, rather than heart failure as shown in FIG. 4). Finally, after clicking on the visualization thumbnail corresponding to anemia, the user may have been presented with the display 550. Alternatively, the display 550 may correspond to a scenario in which the user selected “anemia” as the alignment variable, and then subsequently selected a visualization thumbnail that corresponds to the temporal variable “Alzheimer disease” by clicking on or otherwise selecting that thumbnail.

The example display 550 includes a number of tabs 552-1 through 552-11, including a Genetics and Genomics tab 552-1, an Images tab 552-2, a Course Content tab 552-3, a Curated Content tab 552-4, a Faculty tab 552-5, a PubMed tab 552-6, a Population Stats tab 552-7, a Search Engines tab 552-8, a My Notes tab 552-9, a Public Notes tab 552-10, and an Info tab 552-11. In other embodiments, the display 550 may include more, fewer and/or different tabs than those shown in FIG. 13. Generally, some of tabs 552-1 through 552-11 allow a user to navigate to information related to the alignment and/or temporal variables corresponding to a selected visualization thumbnail. In particular, some of tabs 552-1 through 552-11 provide links to targeted resources to enable users to query those resources for one or both conditions of interest (i.e., the alignment variable and/or the temporal variable).

FIG. 13 corresponds to a scenario in which the Genetics and Genomics tab 552-1 is active. The Genetics and Genomics tab 552-1 may be the default tab when a particular visualization thumbnail is selected (e.g., clicked on), for example. Generally, the Genetics and Genomics tab 552-1 provides links to genomic-related resources. As seen in FIG. 13, the user may activate user-interactive controls to select from among criteria 554 for a search, and to select from among a set of genomic-related search engines 556. In particular, the user may select one or both of the alignment variable and the temporal variable from among criteria 554, and may select one of (or in some embodiments, more than one of) the genomic-related search engines 556 to execute the search according to the selected criteria. Each of the genomic-related search engines 556 may be associated with a respective database or a respective set of databases. The user-interactive controls used to select from among criteria 554 and genomic-related search engines 556 may include radio buttons (as shown in FIG. 13), for example, and/or other suitable types of controls. Once the user has selected the desired one or more of criteria 554 and search engines 556, the user may activate a submit button 560 (or other type of user-interactive control) to initiate the search. The search results may then be displayed to the user in a new window, or within display 550, for example.

In some embodiments, the terms/conditions selected from among criteria 554 may serve as the only keywords for the search. In other embodiments, however, an additional set of one or more terms may be pre-defined or encoded for each of some or all conditions that can be chosen as temporal or alignment variables (and therefore can appear among criteria 554). For example, the phrase and/or individual terms “lung neoplasms” may be mapped to the condition “lung cancer,” with both “lung cancer” and “lung neoplasms” serving as keyphrases or keywords if the user selects the condition “Lung Cancer” from among criteria 554 (e.g., after selecting a visualization thumbnail corresponding to lung cancer and a different condition). Similarly, various terms may have been pre-defined or encoded for many of the database resources that can be searched by search engines 556. For example, each of the conditions that can be chosen as a temporal or alignment variable, as well as a number of the searchable database resources, may be associated with a respective set of one or more MeSH (“Medical Subject Headings”) terms. The MeSH terms associated with the temporal and/or alignment variable may then be used to retrieve database resources associated with one or more matching MeSH terms, for example. Using MeSH or other terms in this manner may lead to a larger number of useful, relevant results, and/or a more useful ordering/ranking of results, than would be obtained if only the condition name itself (e.g., “anemia,” “lung cancer,” etc.) were used as a keyword or keyphrase.

If the user selects the Images tab 552-2, another display (e.g., similar to display 550) may enable a user to search one or more particular image databases. For example, the user may be presented with selectable criteria similar to criteria 554 (e.g., to select the alignment and/or temporal variables), and presented with a number of selectable image search engines or databases. Alternatively, only a single image-based search engine and/or image database may be available. In a manner similar to that discussed above in connection with Genetics and Genomics tab 552-1, both (1) some or all of the conditions that may serve as criteria and (2) some or all of the images in the searchable database(s) may be associated with pre-defined MeSH or other terms to enhance the search results.

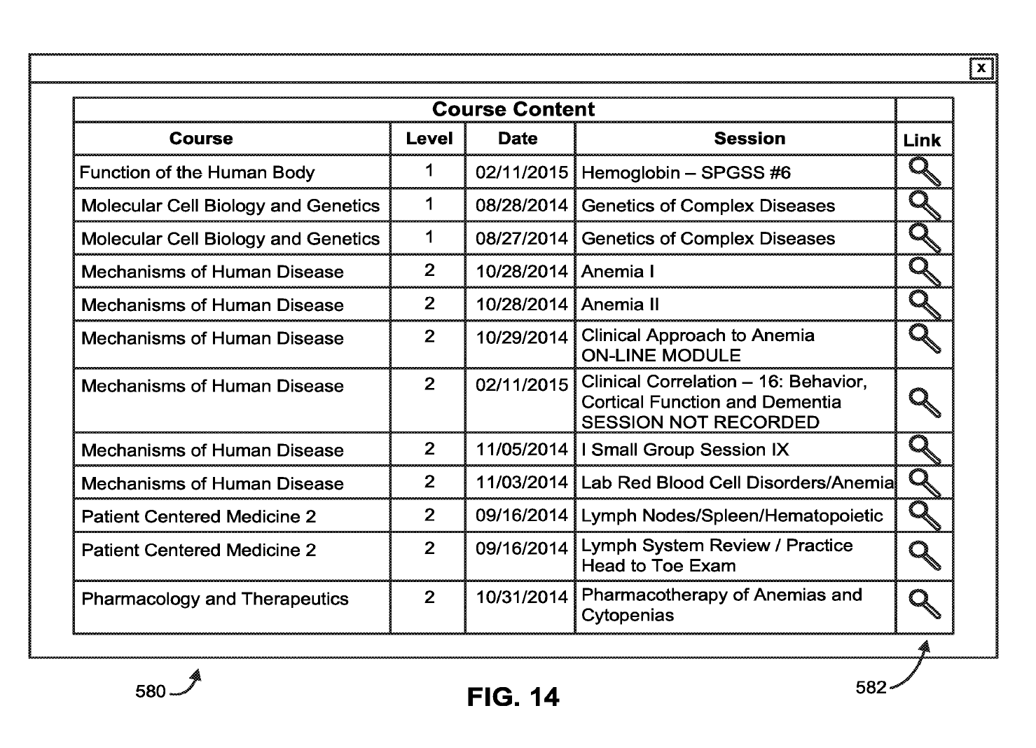

FIG. 14 depicts an example display 580 corresponding to a scenario in which the user has selected Course Content tab 552-3. The display 580 may be a pop-up window, for example. Generally, the Course Content tab 552-3 provides links to educational content associated with one or more medical institutions and/or curricula. As seen in FIG. 14, details (e.g., name, date, etc.) for a number of different courses are presented to the user. The list of courses may be automatically assembled based on course information stored in a course database and a number of keywords or keyphrases. For example, the list of courses may be automatically assembled by using pre-defined MeSH terms associated with the alignment and temporal variables to search the course database, and some or all of the courses may also be associated with pre-defined MeSH terms. In some embodiments, a user may select from among criteria similar to criteria 554 of FIG. 13 (e.g., to select only the temporal variable, only the alignment variable, or both), and the course database may then be searched according to the selected criteria. In the example display 580, each of the courses in the resulting list is associated with one of links 582, which the user may select to retrieve or otherwise gain access the desired course materials (e.g., one or more content items, such as a video download, a web presentation, a powerpoint document, etc.). For example, clicking on one of links 582 may cause a remote server to retrieve the respective course materials and download those materials to the user's client device (e.g., client device 24 of FIG. 1).

If the user selects the Curated Content tab 552-4, another display (e.g., similar to display 550) may enable a user to search one or more curated databases containing information that has been manually vetted by an expert in the relevant field or domain. For example, the user may be presented with selectable criteria similar to criteria 554 (e.g., to select the alignment and/or temporal variables), and the curated databases may be searched according to the selected criteria. In a manner similar to that discussed above in connection with Genetics and Genomics tab 552-1, both (1) some or all of the conditions that may serve as criteria and (2) some or all of the curated pieces of content in the searchable database(s) may be associated with pre-defined MeSH or other terms to enhance the search results.

If the user selects the Faculty tab 552-5, another display (e.g., similar to display 550) may enable a user to search one or more faculty databases containing information about faculty members (e.g., of one or more medical institutions) that are known to have special interests in the alignment and/or temporal variables. For example, the user may be presented with selectable criteria similar to criteria 554 (e.g., to select the alignment and/or temporal variables), and the faculty databases may be searched according to the selected criteria. In a manner similar to that discussed above in connection with Genetics and Genomics tab 552-1, both (1) some or all of the conditions that may serve as criteria and (2) some or all of the faculty members in the searchable database(s) may be associated with pre-defined MeSH or other terms to enhance the search results.

If the user selects the PubMed tab 552-6, another display (e.g., similar to display 550) may link the user to the PubMed search engine. For example, the user may be presented with selectable criteria similar to criteria 554 (e.g., to select the alignment and/or temporal variables), and the PubMed database may be searched according to the selected criteria. In a manner similar to that discussed above in connection with Genetics and Genomics tab 552-1, both (1) some or all of the conditions that may serve as criteria and (2) some or all of the resources searchable by the PubMed search engine may be associated with pre-defined MeSH or other terms to enhance the search results.

The Population Stats tab 552-7 may generally provide a range of descriptive statistics that have been calculated for a targeted alignment variable and temporal variable combination. The Population Stats tab 552-7 may link to the display 350 of FIG. 6, for example, and/or provide a gateway to some or all of the displays 350, 400, 420, 440, 460 and 500 of FIGS. 6, 7, 8, 9, 10 and 11, respectively.

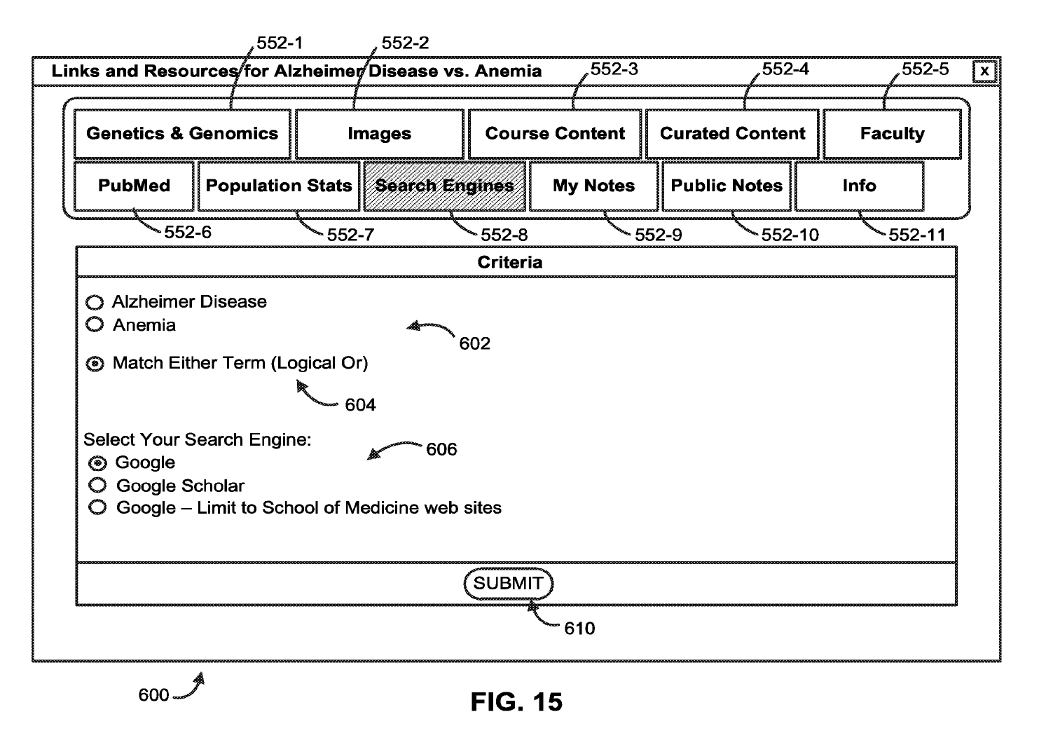

FIG. 15 depicts a display 600 corresponding to a scenario in which the Search Engines tab 552-8 is active. Generally, the Search Engines tab 552-8 provides links to one or more public web search engines (e.g., Google, Google Scholar, etc.). As seen in FIG. 15, the user may activate user-interactive controls to select from among criteria 602 (including logic 604) for a search, and to select from among a set of public search engines 606. As with criteria 554 of FIG. 13, the user may select one or both of the alignment variable and the temporal variable from among criteria 602. Alternatively, the user may select the logic 604 to dictate that a logical “OR” be applied between both the temporal and alignment conditions. Selecting both the alignment and temporal condition, without selecting logic 604, may result in an “AND” operation, for example. While not shown in FIG. 13, the criteria 554 (and/or criteria associated with other tabs 552-1 through 552-11) may also include selectable logic similar to logic 604, in some embodiments. As seen in FIG. 15, user options may be provided to limit the searching by at least one of the public search engines 606 to one or more particular web sites (e.g., of a particular school and/or educational network). Alternatively, or additionally, user options may be provided to limit the searching by at least one of the public search engines 606 to one or more particular databases.

The user-interactive controls used to select from among criteria 602 and public search engines 606 may include radio buttons, for example, and/or other suitable types of controls. Once the user has selected the desired one or more of criteria 602, and has selected one of search engines 606, the user may activate a submit button 610 (or other type of user-interactive control) to initiate the search. The search results may then be displayed to the user in a new window, or within display 600, for example. In a manner similar to that discussed above in connection with Genetics and Genomics tab 552-1, both (1) some or all of the conditions that may serve as criteria and (2) some or all of the resources searchable by the public search engine may be associated with pre-defined MeSH or other terms to enhance the search results.

The My Notes tab 552-9 generally enables a user to enter and save/collect personal notes (e.g., text, URLs, images, etc.) that relate to the aligned/temporal variable combination of the corresponding visualization thumbnail. A user selection of My Notes tab 552-9 may cause a text entry window to pop up, for example, and/or may cause browsing controls (e.g., to upload particular documents to a remote server for storage in a memory) to be presented to the user. In some embodiments, the user is provided with controls to enable the user to flag particular notes as “public” so that all other users (or, in some embodiments, a particular authorized subset of users) may view the notes by selecting the Public Notes tab 552-10. In other embodiments, notes are available to all users by default under the Public Notes tab 552-10, and a note is only omitted from the Public Notes tab 552-10 if the user flags the note as “private.”

The Info tab 552-11 generally provides information about the alignment and temporal variables corresponding to the selected visualization thumbnail. For example, user selection of the Info tab 552-11 (or of links provided under the Info tab 552-11) may cause information about assignment and/or temporal variable calculations and/or criteria to be presented to the user. The Info tab 552-11 may also, or instead, provide other information, such as user help relating to the operation of the visualization tool.

### VI. Example Methods of Longitudinal Event Detection and Visualization

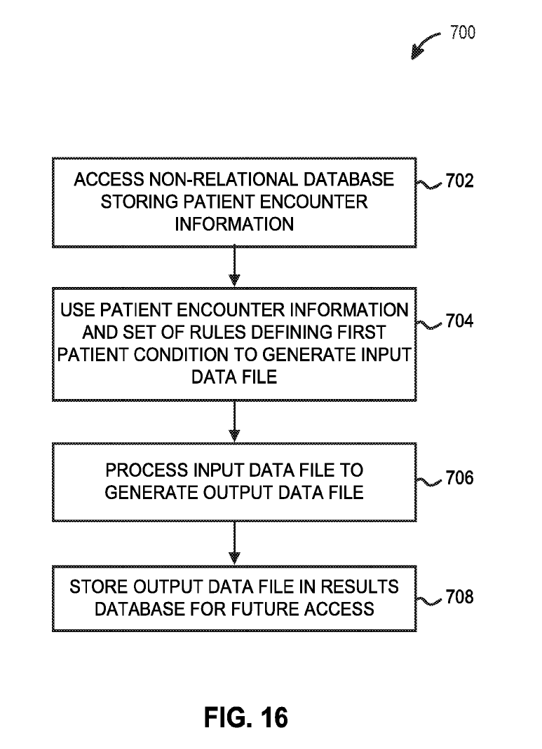

FIG. 16 is a flow diagram of an example method 700 for detecting temporal events using patient database information, according to an embodiment. The method 700 may be implemented in whole or in part by application node 36 of FIG. 1, for example. At block 702, a non-relational (e.g., Hadoop) database storing patient encounter information for a plurality of encounters and a plurality of patients is accessed. Block 702 may include accessing a Hadoop cluster (e.g., Hadoop cluster 20 of FIG. 1) storing the patient encounter information, for example.

At block 704, the stored patient encounter information is used, along with a set of rules defining a first patient condition (e.g., a chronic disease such as hypertension or asthma, or a condition such as obesity, etc.), to generate an input data file having a plurality of patient entries. The set of rules defines a size of a temporal window, and includes one or more rules for determining whether the first patient condition is expressed within any given instance of the temporal window. Each patient entry of the plurality of patient entries corresponds to a respective patient of the plurality of patients, and includes, for each encounter of the plurality of encounters that is associated with the respective patient: an encounter identifier associated with the encounter, a temporal indicator specifying a date of the encounter, and a set of attribute values associated with the encounter. The set of attribute values may include one or more diagnoses (e.g., ICD9 and/or ICD10 codes) for the respective patient, an indication of whether each of the one or more diagnoses is a primary or secondary diagnosis, an indication of whether the encounter is an inpatient or outpatient encounter, and/or other information.

At block 706, the input data file is processed to generate an output data file. Block 706 may include, for each patient entry of the plurality of patient entries, (1) identifying an instance of the temporal window, (2) processing a portion of the patient entry that corresponds to encounters that occurred within the identified instance of the temporal window to determine whether the one or more rules are satisfied for the identified instance of the temporal window (e.g., at least in part by analyzing, for each encounter that occurred within the identified instance of the temporal window, the set of attribute values associated with the encounter), (3) adding to the output data file an indication of whether the one or more rules were satisfied in the identified instance of the temporal window, and (4) repeating (1) through (3) for a plurality of instances of the temporal window. The instance of the temporal window may be identified at least partly by using the temporal indicators of the encounters associated with the patient corresponding to the patient entry to determine a next position of the temporal window. At block 708, the output data file is stored in a results database for future access via one or more data analytics tools (e.g., a tool capable of providing the displays of one or more of FIGS. 3-15). In some embodiments, the method 700 may include one or more additional blocks not shown in FIG. 16.

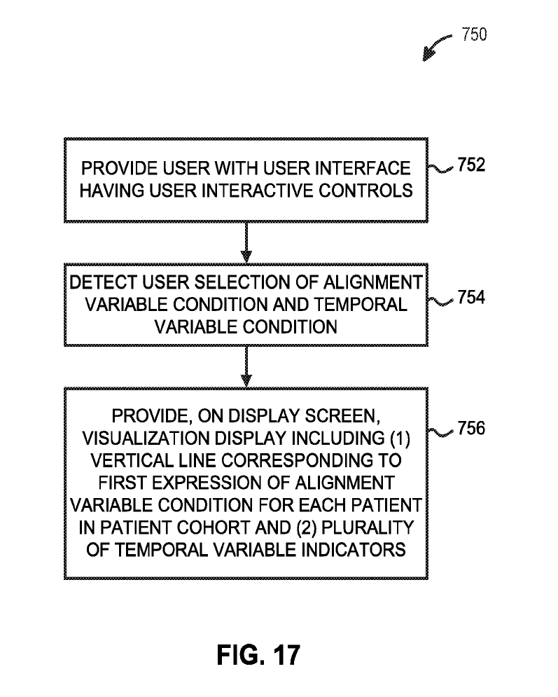

FIG. 17 is a flow diagram of an example method 750 for visualizing temporal events for a patient cohort, according to an embodiment. The method 750 may be implemented in whole or in part by application node 36 of FIG. 1, for example. At block 752, a user at a client device (e.g., client device 24 of FIG. 1) is provided with a user interface having user interactive controls. The user interactive controls include an alignment variable control to enable selection from among a first plurality of conditions that can be expressed by patients, and a temporal variable control to enable selection from among a second plurality of conditions that can be expressed by patients. The first plurality of conditions may include some or all conditions included in the second plurality of conditions. In some embodiments, the user interactive controls may also include one or more demographic controls that enable user selection of demographic criteria (e.g., gender, ethnicity, etc.), a logic control that enables user selection of temporal variable logic criteria, and/or a window size control.

At block 754, user selection of an alignment variable condition (via the alignment variable control and from among the first plurality of conditions) and a temporal variable condition (via the temporal variable control and from among the second plurality of conditions) is detected. After block 754, at block 756, a visualization display is provided on a display screen of the client device. The visualization display has an x-axis and a y-axis, and includes a vertical line corresponding to a first expression of the alignment variable condition for each patient in the patient cohort, as well as a plurality of temporal variable indicators. The vertical line is parallel to the y-axis and corresponds in time to a first expression of the selected alignment variable condition for each patient in the patient cohort. Each temporal variable indicator of the plurality of temporal variable indicators corresponds to a respective patient of the patient cohort and has (i) a different coordinate along the y-axis, and (ii) a coordinate along the x-axis that is offset from the vertical line by an amount proportional to a difference in time between the first expression of the selected alignment variable condition for the respective patient and a first expression of the selected temporal variable condition for the respective patient. In some embodiments, each condition of the second plurality of conditions is associated with a different color, and each of the displayed temporal variable indicators is color-coded with the color associated with the selected temporal variable condition. In some embodiments, block 756 includes accessing a results database storing temporal event information for a plurality of patients that includes the patient cohort. The temporal event information may include, for each patient in the plurality of patients, for each condition in the first and/or the second plurality of conditions, and for each temporal window of a respective set of temporal windows, an indication of whether the patient expressed the condition during the temporal window.

In some embodiments, the method 750 may include one or more additional blocks not shown in FIG. 17. In one embodiment where the user interactive controls include a logic control, for example, and where block 754 includes detecting a user selection of a plurality of temporal variable conditions, the method 750 includes additional blocks in which a user selection of one or more temporal variable logic criteria (made via the temporal variable logic control) is detected, and in which the patient cohort is restricted to only patients that expressed the one(s) of the selected temporal variable conditions in accordance with the selected temporal variable logic criterion or criteria. As another example, in an embodiment where the user interactive controls includes a window size control, the method 750 includes an additional block in which a user selection of a window size (made via the window size control) is detected. In this latter embodiment, the temporal variable indicators may include horizontal line segments each having a length corresponding to the selected window size.

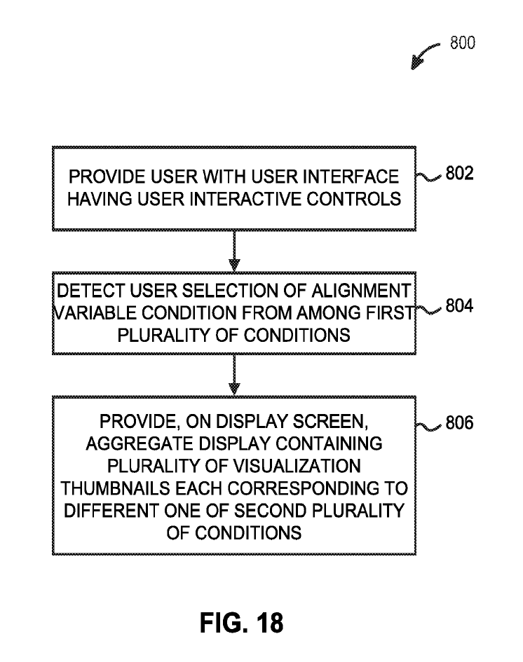

FIG. 18 is a flow diagram of another example method 800 for visualizing temporal events for a patient cohort, according to an embodiment The method 800 may be implemented in whole or in part by application node 36 of FIG. 1, for example. At block 802, a user at a client device (e.g., client device 24 of FIG. 1) is provided with a user interface having user interactive controls. The user interactive controls include an alignment variable control to enable selection from among a first plurality of conditions that can be expressed by patients (e.g., chronic diseases and/or other conditions, such as obesity). The user interactive controls may also include other controls, such as one or more demographic controls that enable user selection of demographic criteria.

At block 804, a user selection of an alignment variable condition, made via the alignment variable control and from among the first plurality of conditions, is detected. After block 804, at block 806, an aggregate display is provided on a display screen of the client device. The aggregate display contains a plurality of visualization thumbnails each having a respective x-axis and a respective y-axis, and each corresponding to a different one of a second plurality of conditions (e.g., chronic diseases and/or other conditions). The first plurality of conditions may include some or all conditions included in the second plurality of conditions. The aggregate display includes, for each of the visualization thumbnails, a vertical line that is parallel to the respective y-axis and corresponds in time to a first expression of the selected alignment variable condition for each patient in the patient cohort. The aggregate display also includes, for each of the visualization thumbnails, a plurality of temporal variable indicators. Each of the temporal variable indicators corresponds to a respective patient of the patient cohort and has a different coordinate along the respective y-axis and a coordinate along the respective x-axis that is offset from the vertical line by a certain amount. In particular, the amount may be proportional to a difference in time between the first expression of the selected alignment variable condition for the respective patient and a first expression of the condition, of the second plurality of conditions, that corresponds to the visualization thumbnail.

In some embodiments, each condition of the second plurality of conditions is associated with a different color, and each of the temporal variable indicators is color-coded with the color associated with the condition that corresponds to the visualization thumbnail. Moreover, in some embodiments, block 806 includes accessing a results database storing temporal event information for a plurality of patients that includes the patient cohort. The temporal event information may include, for each patient in the plurality of patients, for each condition in the first and/or second plurality of conditions, and for each temporal window of a respective set of temporal windows, an indication of whether the patient expressed the condition during the temporal window.

In some embodiments, the method 800 may include one or more additional blocks not shown in FIG. 18. In one embodiment where the user interactive controls include one or more demographic controls, for example, the method 800 may include additional blocks, prior to block 806, in which a user selection (made via the demographic control(s)) of one or more demographic criteria is detected, and in which the patient cohort is restricted to only those patients meeting the selected demographic criterion or criteria.

### VII. Additional Considerations

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for detecting and/or visualizing temporal events in a large-scale patient database through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A computer-implemented method for detecting temporal events using patient database information, the method comprising:
accessing, by one or more processors in one or more hardware servers, a non-relational database storing patient encounter information for a plurality of encounters and a plurality of patients;
using, by the one or more processors, (i) the stored patient encounter information, and (ii) a set of rules defining a first patient condition, to generate an input data file having a plurality of patient entries, wherein
the set of rules (i) defines a size of a temporal window and (ii) includes one or more rules for determining whether the first patient condition is expressed within any given instance of the temporal window, and
each patient entry of the plurality of patient entries
corresponds to a respective patient of the plurality of patients, and
includes, for each encounter of the plurality of encounters that is
associated with the respective patient, (i) an encounter identifier associated with the encounter, (ii) a temporal indicator specifying a date of the encounter, and (iii) a set of attribute values associated with the encounter; and
processing, by the one or more processors, the input data file to generate an output data file, wherein processing the input data file to generate the output file includes, for each patient entry of the plurality of patient entries,
(a) identifying an instance of the temporal window,
(b) processing a portion of the patient entry that corresponds to encounters that occurred within the identified instance of the temporal window to determine whether the one or more rules are satisfied for the identified instance of the temporal window, at least in part by analyzing, for each encounter that occurred within the identified instance of the temporal window, the set of attribute values associated with the encounter,
(c) adding to the output data file an indication of whether the one or more rules were satisfied in the identified instance of the temporal window, and
(d) repeating (a) through (c) for a plurality of instances of the temporal window; and
storing, by the one or more processors, the output data file in a results database for future access via one or more data analytics tools.

2. The computer-implemented method of claim 1, wherein accessing a non-relational database includes accessing a Hadoop cluster storing the patient encounter information.

3. The computer-implemented method of claim 1, wherein using a set of rules defining a first patient condition to generate the input data file includes using a set of rules defining a chronic disease to generate the input data file.

4. The computer-implemented method of claim 1, wherein the set of attribute values includes one or more diagnoses for the respective patient.

5. The computer-implemented method of claim 4, wherein for each patient entry, and for each encounter associated with the respective patient, the set of attribute values includes (i) the one or more diagnoses for the respective patient, and (ii) an indication of whether each of the one or more diagnoses for the respective patient is a primary diagnosis or a secondary diagnosis.

6. The computer-implemented method of claim 4, wherein for each patient entry, and for each encounter associated with the respective patient, the set of attribute values includes (i) the one or more diagnoses for the respective patient, and (ii) an indication of whether the encounter is an inpatient encounter or an outpatient encounter.

7. The computer-implemented method of claim 1, wherein for each patient entry, and for each encounter associated with the respective patient, the set of attribute values includes one or more International Classification of Diseases, Ninth Revision (ICD9) codes for the respective patient.

8. The computer-implemented method of claim 1, wherein identifying an instance of the temporal window includes using the temporal indicators of the encounters associated with the patient corresponding to the patient entry to determine a next position of the temporal window.

9. A computer-implemented method for visualizing temporal events for a patient cohort, the method comprising:
providing, by one or more processors, a user at a client device with a user interface having user interactive controls, the user interactive controls including (i) an alignment variable control to enable selection from among a first plurality of conditions that can be expressed by patients, and (ii) a temporal variable control to enable selection from among a second plurality of conditions that can be expressed by patients;
detecting, by one or more processors, (i) a user selection, via the alignment variable control and from among the first plurality of conditions, of an alignment variable condition, and (ii) a user selection, via the temporal variable control and from among the second plurality of conditions, of a temporal variable condition;
after detecting the user selection of the alignment variable condition and the user selection of the temporal variable condition, providing, by one or more processors and on a display screen of the client device, a visualization display having an x-axis and a y-axis, wherein providing the visualization display includes
displaying a vertical line that is parallel to the y-axis and corresponds in time to a first expression of the selected alignment variable condition for each patient in the patient cohort, and
displaying a plurality of temporal variable indicators, each temporal variable indicator of the plurality of temporal variable indicators corresponding to a respective patient of the patient cohort and having (i) a different coordinate along the y-axis, and (ii) a coordinate along the x-axis that is offset from the vertical line by an amount proportional to a difference in time between the first expression of the selected alignment variable condition for the respective patient and a first expression of the selected temporal variable condition for the respective patient.

10. The computer-implemented method of claim 9, wherein:
providing the user with a user interface having user interactive controls includes providing the user with a user interface having user interactive controls that include (i) an alignment variable control to enable selection from among a first plurality of chronic diseases, and (ii) a temporal variable control to enable selection from among a second plurality of chronic diseases; and
the first plurality of chronic diseases includes some or all chronic diseases included in the second plurality of chronic diseases.

11. The computer-implemented method of claim 9, wherein:
providing the user with a user interface having user interactive controls includes providing the user with a user interface having user interactive controls that include (i) the alignment variable control, (ii) the temporal variable control, and (iii) one or more demographic controls that enable user selection of demographic criteria; and
the method further comprises, prior to providing the visualization display,
detecting, by one or more processors, a user selection, via the one or more demographic controls, of one or more demographic criteria, and
restricting, by one or more processors, the patient cohort to only those patients meeting the selected one or more demographic criteria.

12. The computer-implemented method of claim 9, wherein:
providing the user with a user interface having user interactive controls includes providing the user with a user interface having user interactive controls that include (i) the alignment variable control, (ii) the temporal variable control, and (iii) a logic control that enables user selection of temporal variable logic criteria;
detecting a user selection of a temporal variable condition includes detecting a user selection of a plurality of temporal variable conditions; and
the method further comprises, prior to providing the visualization display,
detecting, by one or more processors, a user selection, via the temporal variable logic control, of one or more temporal variable logic criteria, and
restricting, by one or more processors, the patient cohort to only patients that expressed one or more of the selected plurality of temporal variable conditions in accordance with the selected one or more temporal variable logic criteria.

13. The computer-implemented method of claim 9, wherein:
providing the user with a user interface having user interactive controls includes providing the user with a user interface having user interactive controls that include (i) the alignment variable control, (ii) the temporal variable control, and (iii) a window size control;
the method further comprises, prior to providing the visualization display, detecting, by one or more processors, a user selection, via the window size control, of a window size; and
displaying a plurality of temporal variable indicators includes displaying a plurality of horizontal line segments each having a length corresponding to the selected window size.

14. The computer-implemented method of claim 9, wherein:
each condition of the second plurality of conditions is associated with a different color; and
displaying a plurality of temporal variable indicators includes displaying a plurality of temporal variable indicators each being color-coded with the color associated with the selected temporal variable condition.

15. The computer-implemented method of claim 9, wherein:
providing the visualization display includes accessing a results database storing temporal event information for a plurality of patients that includes the patient cohort; and
the temporal event information includes, for (i) each patient in the plurality of patients, (ii) each condition in one or both of the first plurality of conditions and the second plurality of conditions, and (iii) each temporal window of a respective set of temporal windows, an indication of whether the patient expressed the condition during the temporal window.

16. A computer-implemented method for visualizing temporal events for a patient cohort, the method comprising:
providing, by one or more processors, a user at a client device with a user interface having user interactive controls, the user interactive controls including an alignment variable control to enable selection from among a first plurality of conditions that can be expressed by patients;
detecting, by one or more processors, a user selection, via the alignment variable control and from among the first plurality of conditions, of an alignment variable condition;
after detecting the user selection of the alignment variable condition, providing, by one or more processors and on a display screen of the client device, an aggregate display containing a plurality of visualization thumbnails each (i) having a respective x-axis and a respective y-axis and (ii) corresponding to a different one of a second plurality of conditions, wherein providing the aggregate display includes, for each visualization thumbnail of the plurality of visualization thumbnails,
displaying a vertical line that is parallel to the respective y-axis and corresponds in time to a first expression of the selected alignment variable condition for each patient in the patient cohort, and
displaying a plurality of temporal variable indicators, each temporal variable indicator of the plurality of temporal variable indicators corresponding to a respective patient of the patient cohort and having (i) a different coordinate along the respective y-axis, and (ii) a coordinate along the respective x-axis that is offset from the vertical line by an amount proportional to a difference in time between the first expression of the selected alignment variable condition for the respective patient and a first expression of the condition, of the second plurality of conditions, that corresponds to the visualization thumbnail.

17. The computer-implemented method of claim 16, wherein:
providing the user with a user interface having user interactive controls includes providing the user with a user interface having user interactive controls that include an alignment variable control to enable selection from among a first plurality of chronic diseases;
providing an aggregate display containing a plurality of visualization thumbnails includes providing an aggregate display containing a plurality of visualization thumbnails each corresponding to a different one of a second plurality of chronic diseases; and
the first plurality of chronic diseases includes some or all chronic diseases included in the second plurality of chronic diseases.

18. The computer-implemented method of claim 16, wherein:
providing the user with a user interface having user interactive controls includes providing the user with a user interface having user interactive controls that include (i) the alignment variable control, and (ii) one or more demographic controls that enable user selection of demographic criteria; and
the method further comprises, prior to providing the aggregate display,
detecting, by one or more processors, a user selection, via the one or more demographic controls, of one or more demographic criteria, and
restricting, by one or more processors, the patient cohort to only those patients meeting the selected one or more demographic criteria.

19. The computer-implemented method of claim 16, wherein:
each condition of the second plurality of conditions is associated with a different color; and
displaying a plurality of temporal variable indicators includes displaying a plurality of temporal variable indicators each being color-coded with the color associated with the condition that corresponds to the visualization thumbnail.

20. The computer-implemented method of claim 16, wherein:
providing the aggregate display includes accessing a results database storing temporal event information for a plurality of patients that includes the patient cohort; and
the temporal event information includes, for (i) each patient in the plurality of patients, (ii) each condition in one or both of the first plurality of conditions and the second plurality of conditions, and (iii) each temporal window of a respective set of temporal windows, an indication of whether the patient expressed the condition during the temporal window.
